(19) United States
(12) Patent Application Publication
(10) Pub. No.: US 2025/0109460 A1
(43) Pub. Date: Apr. 3, 2025

(54) Production of Neodymium and Other Rare Earth Metals Using Hydrogen Augmented Magnesium Alloy

(71) Applicant: University of Utah Research Foundation, Salt Lake City, UT (US)

(72) Inventors: Munro ALLEY, Salt Lake City, UT (US); Pei SUN, Salt Lake City, UT (US); Zhigang Zak FANG, Salt Lake City, UT (US)

(21) Appl. No.: 18/902,527

(22) Filed: Sep. 30, 2024

Related U.S. Application Data
(60) Provisional application No. 63/586,624, filed on Sep. 29, 2023.

(51) Int. Cl. C22B 59/00; C22B 7/00; C22C 1/02; C22C 23/06

(52) U.S. Cl. CPC C22B 59/00; C22B 7/002; C22B 7/004; C22C 1/02; C22C 23/06

(57) ABSTRACT

A method of producing a neodymium metal can include mixing a dissolution agent comprising magnesium with a neodymium-containing feedstock. The dissolution agent and the neodymium-containing feedstock can be heated to an elevated temperature above a melting temperature of the dissolution agent to form a neodymium-magnesium alloy. The neodymium-magnesium alloy can be exposed to hydrogen gas to convert neodymium in the alloy to a neodymium hydride. The neodymium hydride can be separated from the magnesium in the alloy. The neodymium can be optionally dehydrogenated to yield a purified neodymium product.

### CROSS REFERENCE TO RELATED APPLICATIONS

This application claims priority to U.S. Provisional Patent Application No. 63/586,624, filed Sep. 29, 2023, which is hereby incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

Rare earth metals are used in a variety of applications. Neodymium, one of the rare earth metals, is an element included in high-strength Nd₂Fe₁₄B magnets. These magnets are used in many technologies, including electric generators in wind power plants, consumer electronics, and motors that range in size from those used in power tools to electric vehicles. The use of such magnets in motors can help compete against internal combustion engine vehicles, making neodymium a useful material for improving global sustainability. Neodymium has been produced from mined ores that contain neodymium oxides, such as Nd₂O₃. A few processes have been used to reduce neodymium oxide to produce neodymium metal, including metallothermic reduction using calcium and molten salt electrolysis using molten NdF₃ and LiF salt. Waste magnets are also an increasingly attractive source for neodymium. Recycling techniques have been investigated, but it remains difficult to effectively recycle neodymium from waste magnets.

Some prior processes that have been used to recycle neodymium magnets include hydrometallurgical methods and pyrometallurgical methods. The hydrogenation-disproportionation-desorption-recombination (HDDR) method is one particular process used to recycle magnets from dismantled wind turbines. In this method, NdFeB magnets are exposed to hydrogen at elevated temperature. This forms neodymium hydride at grain boundaries in the alloy. The formation of the neodymium hydride causes a volume expansion that can break the NdFeB magnets into powder and demagnetize them in one step. This powder can then be re-sintered into new magnets. Unfortunately, oxygen contamination is difficult to avoid in this process. Some of the neodymium on the surface of the powder particles is oxidized during the recycling process, and this results in reduced magnetic properties in the reprocessed magnets compared to the virgin magnets. The neodymium oxide remains at grain boundaries in the reprocessed magnet after sintering. This can decrease the magnetic isolation of the individual grains, and thus decrease the coercivity. This degradation has sometimes been addressed by mixing recycled NdFeB powder with virgin powder or other additives when making the reprocessed magnet. However, the continued consumption of rare materials in the recycling process means that this is not a truly circular recycling strategy.

### SUMMARY

A method of producing a metallic neodymium can include mixing a dissolution agent with a neodymium-containing feedstock, where the dissolution agent comprises magnesium. The mixed dissolution agent and feedstock can be heated to an elevated temperature above a melting temperature of the dissolution agent to form a neodymium-magnesium alloy. The neodymium-magnesium alloy can be exposed to hydrogen gas to convert neodymium in the alloy to neodymium hydride. The neodymium hydride can be separated from the magnesium and the remaining neodymium-magnesium alloy. The neodymium hydride can then be optionally dehydrogenated after separation from the magnesium and any remaining neodymium-magnesium alloy. In certain examples, the neodymium-containing feedstock can include a neodymium oxide. In other examples, the neodymium-containing feedstock can include a neodymium-containing waste, a recycled neodymium-containing material, a neodymium-containing scrap material, or a combination thereof. It is also contemplated that this process can be used with other rare earth metals.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a standard Ellingham diagram showing the standard free energy of formation for Al₂O₃, MgO, CaO, and Nd₂O₃.

FIG. 2 is a flowchart of an example method of producing a rare earth metal in accordance with the present disclosure.

FIG. 3 is a flowchart showing an example method of producing neodymium from Nd₂O₃ in accordance with the present disclosure.

FIG. 4 is a flowchart of another example method of producing a rare earth metal in accordance with the present disclosure.

FIG. 5 is a flowchart of another example method of producing a rare earth metal in accordance with the present disclosure.

FIG. 6 is a flowchart of a different example method of producing a rare earth metal in accordance with the present disclosure.

FIG. 7 is a flowchart showing an additional example method of producing a rare earth metal in accordance with the present disclosure.

FIG. 8 is a graph of Gibbs free energy of formation of Mg—Nd alloys at 707° C. across the range of mole fractions of Nd in the Mg—Nd alloys.

FIG. 9 is an X-ray diffraction spectrum of a reduced product from a method of producing a rare earth metal in accordance with the present disclosure.

FIG. 10 is another X-ray diffraction spectrum of a reduced product from a method of producing a rare earth metal in accordance with the present disclosure.

FIGS. 11-14 are SEM images of reduced products from a method of producing a rare earth metal in accordance with the present disclosure.

FIG. 15 is an SEM image of a Mg—Nd alloy made using a method of producing a rare earth metal in accordance with the present disclosure.

FIG. 16 is an EDS image of NdHₓ crystals made using a method of producing a rare earth metal in accordance with the present disclosure.

FIG. 17 is a BSED pattern of NdHₓ crystals made using a method of producing a rare earth metal in accordance with the present disclosure.

FIG. 18 is an EDS image of Nd made using a method of producing a rare earth metal in accordance with the present disclosure.

FIG. 19 is a plot of equilibrium mole fraction of Nd in a Mg—Nd solution vs. temperature.

FIG. 20 is a plot of extent of reduction and equilibrium Nd concentration in an Mg—Nd alloy vs. the initial ratio of Nd₂O₃ to Mg.

FIG. 21 is a plot of extent of reduction and equilibrium Nd concentration in an Mg—Nd alloy vs. the initial ratio of CaCl₂ to Mg.

FIG. 22 is an X-ray diffraction spectrum of a reduced product from another example method of producing a rare earth metal in accordance with the present disclosure.

FIG. 23 is another X-ray diffraction spectrum of another reduced product from a different example method of producing a rare earth metal in accordance with the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention.

### Definitions

In describing and claiming the present invention, the following terminology will be used.

As used herein, the terms “hydrogen atmosphere” can refer to a gas that includes at least some hydrogen gas, and in some cases at least 20% by volume of hydrogen. In some embodiments, the hydrogen atmosphere comprises primarily hydrogen that was not produced from particulate metallic feed material. In some examples, the hydrogen atmosphere can be substantially pure hydrogen, while in other examples the hydrogen atmosphere may include one or more other components. In certain examples, a hydrogen atmosphere can be oxygen-free. In further examples, a hydrogen atmosphere can include a mixture of hydrogen and argon. The partial pressure of hydrogen in a hydrogen atmosphere can vary. In some examples, a hydrogen atmosphere can have a hydrogen partial pressure from about 0.01 atm to about 10 atm. It is noted that some processes described herein can include chemical reactions that produce various gases or vapors. Thus, even when a pure hydrogen atmosphere is applied, some of these reaction products can also be present in the atmosphere. Accordingly, if a pure hydrogen atmosphere or a substantially pure hydrogen is described, this atmosphere can encompass a small amount of gaseous or vapor reaction products that may be produced and which may enter the atmosphere. In some examples, a continuous flow of hydrogen can be used to remove such reaction products and replace the atmosphere with pure hydrogen.

As used herein, “rare earth metal-containing feedstock” refers to a feedstock that contains rare earth metal in any form, whether in a metallic form, an oxidized form, an alloyed form, or another chemical compound that includes a rare earth metal atom, and so on.

As used herein, “alloy” refers to a metallic substance composed of a metallic element and one more alloying element(s), as either a compound or as a solution, or a combination of solutions and compound(s), where the alloying elements dissolve in or form a compound(s) with the metallic elements to form at least one phase comprised of the metallic element and the alloying element(s).

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The use of the terms “a” and “an” and “the” and similar referents in the context of describing the elements (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Methods of Producing Neodymium Metal and Other Rare Earth Metals

The present disclosure describes methods of producing rare earth metals from various rare earth metal-containing feedstocks via a process including dissolution and optional reduction, alloying, and crystallization of hydrides. These methods can be used to produce neodymium (Nd) metals, as well as various other rare earth elements, including cerium (Ce), europium (Eu), gadolinium (Gd), lanthanum (La), praseodymium (Pr), promethium (Pm), samarium (Sm), dysprosium (Dy), terbium (Tb), and ytterbium (Yb). Because of the high demand for neodymium for use in rare earth magnets, neodymium is used in many of the examples disclosed herein and is particularly suited to processing using these methods.

Neodymium is currently commonly produced using a molten salt electrolysis process. In this process, neodymium oxide is dissolved into a molten NdF₃ and LiF mixture at temperatures above the melting point of Nd (1,021° C.), forming Nd-oxyfluoride. This oxyfluoride is reduced to liquid Nd metal electrolytically in a refractory metal cathode crucible where it can be collected to pour ingots. This electrolytic reduction produces oxygen that reacts with a consumable carbon anode, forming CO and CO₂. In addition to these direct carbon emissions, the carbon anode also reacts to some extent with the molten fluoride salts, producing perfluorocarbons (PFCs), primarily tetrafluoromethane (CF₄) and hexafluoroethane (C₂F₆). These chemicals are released to the atmosphere where they possess a climate warming potential thousands of times greater than CO₂ with a lifetime of thousands of years. Furthermore, The Nd- and Li-fluoride are both produced through reaction of Nd/Li oxide (or other precursor compound) with hydrogen fluoride, a highly corrosive and harmful chemical.

Despite these issues, the relative simplicity of operation and low reagent cost of the molten salt electrolysis process have led to it being a dominant process for neodymium production. Some modifications to this process have been attempted using a mixed chloride electrolyte instead of fluorides. While some progress has been made in this direction, the technology is still in the early stages of development. One issue with these processes is the use of NdCl₃, which is produced using a carbothermal chlorination reaction that directly produces CO₂, meaning despite the avoidance of fluoride compounds, the process would be even more directly carbon intensive.

Before the development of molten salt electrolysis processes, metallothermic reduction using calcium was a common production method for neodymium and other rare earth elements. In some cases, neodymium chloride or fluoride was mixed with calcium (or less commonly, lithium) in a tantalum bomb crucible and heated to temperatures in the range of 800-1000° C. At these temperatures, the calcium can reduce the neodymium halide to neodymium metal, resulting in a liquid calcium halide slag phase that separates easily from the metal phase due to the density difference between the two. This method had the drawback of using either NdF₃ or NdCl₃ as a feed material, both of which are highly hygroscopic and therefore should be handled carefully to avoid excessive water pickup. Additionally, NdF₃ are prepared from Nd₂O₃ and HF, while NdCl₃ forms oxychlorides that complicate reduction by introducing calcium oxide into the slag. For these reasons, an alternative to Nd-halide reduction was sought in the form of calciothermic reduction of neodymium oxide. This route was investigated by others, but ultimately ruled out due to the high melting point of calcium oxide preventing it from melting, which resulted in poor separation of the metal and oxide phases during reduction.

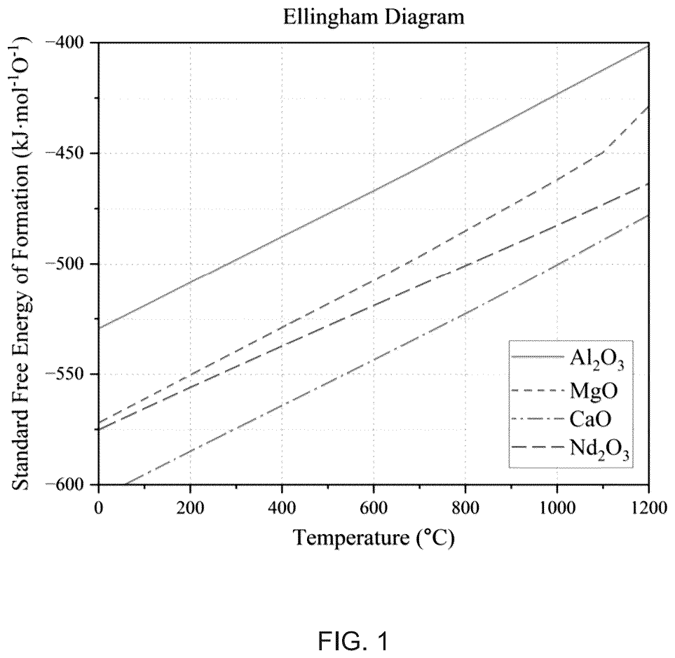

FIG. 1 is a standard Ellingham diagram showing the standard free energy of formation for Al₂O₃, MgO, CaO, and Nd₂O₃. Based on this diagram, it appears that calcium should be a good candidate capable of reducing neodymium from neodymium oxide. The standard free energy of formation for MgO is above Nd₂O₃ at all temperatures on this chart. However, the energies of MgO and Nd₂O₃ are close enough that an equilibrium exists between the two, which allows for some reduction of Nd₂O₃ by Mg. The Nd was separated from Mg by vacuum distillation. However, this process was abandoned due to the low yield of Nd and the high energy cost of vacuum distillation. For these reasons, it has commonly been believed that reducing Nd₂O₃ using Mg is not feasible.

The present disclosure describes methods for producing rare earth metal that utilize magnesium and hydrogen. Compared to the prior processes described above, the methods described herein can produce rare earth metals using safe and inexpensive reactants, namely, Mg and H₂ gas, in an energy efficient way while reducing harm to the environment by eliminating the emission of carbon oxides, perfluorocarbons, and other hazardous compounds. In the methods described herein, a rare earth metal-containing feedstock such as Nd₂O₃ can be heated together with a dissolution agent where the dissolution agent comprises magnesium. This can form an alloy of magnesium and the rare earth metal in its metallic state. Although the Ellingham diagram suggests that it is thermodynamically unfavorable to reduce Nd₂O₃ using magnesium, it has recently been found that if the reaction product is considered to be an alloy of magnesium and neodymium, then it is thermodynamically favorable to form the alloy from Nd₂O₃. A similar reaction can occur with other rare earth metal oxides.

After the rare earth metal-magnesium alloy has formed, the rare earth metal can be separated from the magnesium. In previous processes, this was attempted using vacuum distillation, which has a high energy cost. However, the methods described herein utilize hydrogen gas to hydrogenate the rare earth metal in the alloy. The rare earth metal hydride can have a higher melting point than that of the magnesium dissolution agent allowing for hydride to be easily separated by precipitation at a temperature above the melting point of the dissolution agent and below that of the hydride. In the case of neodymium, the hydrogenation product is NdHₓ where x can range from about 2 to 3. The NdHₓ has a higher melting point temperature than the neodymium-magnesium alloy. Therefore, the neodymium-magnesium alloy can be heated to a temperature that is above the alloy melting point but below the NdHₓ melting point. The solid NdHₓ can then be separated easily from the molten alloy. This separation process can be used to separate nearly pure NdHₓ from the Mg—Nd alloy. The methods described herein can also include a dehydrogenation process, in which the NdHₓ is heated under vacuum or a non-hydrogen atmosphere. This can cause the NdHₓ to give off H₂ gas and leave Nd metal. If a small amount of magnesium remains in the solid at this point, the magnesium can be removed by evaporation since magnesium is present as significant vapor at the temperatures used for dehydrogenation.

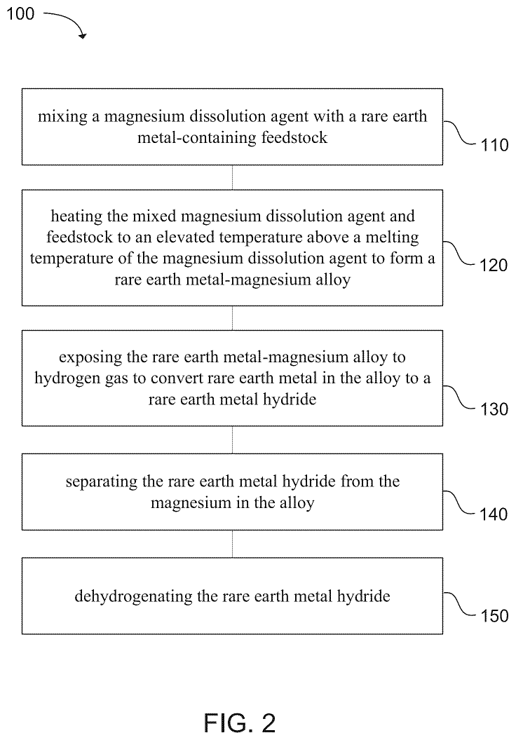

FIG. 2 is a flowchart of an example method 100 of producing a rare earth metal. The method includes: mixing a dissolution agent with a rare earth metal-containing feedstock 110; heating the mixed dissolution agent and feedstock to an elevated temperature above a melting temperature of the dissolution agent to form a rare earth metal-magnesium alloy 120; exposing the rare earth metal-magnesium alloy to hydrogen gas to convert rare earth metal in the alloy to a rare earth metal hydride 130; separating the rare earth metal hydride from the magnesium in the alloy 140 (e.g. via a precipitation step as described below); and optionally dehydrogenating the rare earth metal hydride 150. The dissolution agent comprises magnesium. When the rare earth metal-containing feedstock is a metal oxide, some of the magnesium acts to reduce the rare earth metal oxide, thereby producing magnesium oxide.

In addition to producing rare earth metals from rare earth metal oxides, the methods described herein can be used to produce rare earth metals from rare-earth metal containing waste, recycled rare earth metal-containing materials, or rare earth metal-containing scrap materials. These materials can contain rare earth metal in its metallic form, as opposed to an oxide. In some cases, minor amounts of oxides may be present (e.g. especially along exposed surfaces). However, these materials can also include other materials, such as other metals alloyed with the rare earth metal. For example, waste neodymium magnets can include iron and boron alloyed with neodymium. The methods described herein can be used to separate and purify the neodymium from the other materials. The addition of a dissolution agent which comprises magnesium can help ensure that the neodymium is not oxidized during the process and to reduce the minor amounts of oxides present. In some examples, if the feedstock material is a waste, scrap, or recycled material, then the methods can include one or more additional steps before the step of heating the rare earth metal-containing feedstock material with the dissolution agent. In certain examples, these additional steps can include comminuting the feedstock. In further examples, these additional steps can include an initial hydrogenation step, in which the feedstock can be exposed to hydrogen. In some cases, the hydrogenation can help with comminution of the feedstock.

The methods described herein can avoid oxidation of rare earth metal in a recycled feedstock material. Therefore, the rare earth metal can be re-used to make new products, such as new magnets, that do not have degraded performance.

Feedstocks that can be processed using the methods described herein include materials containing rare earth metals and/or rare earth metal oxides. Some examples include neodymium oxide (Nd₂O₃), rare earth metal oxide-containing ores, rare earth metal-containing waste materials, rare earth metal-containing recycled materials, rare earth metal-containing scrap, scrap rare earth magnets, and others. In these feedstocks, the rare earth metal can include Ce, Eu, Gd, La, Nd, Pr, Pm, Sm, Yb, Dy, Tb, or a combination thereof. In certain examples, the rare earth metal can be Nd. In further examples, the feedstock can include recycled or waste NdFeB magnets. In certain examples, the feedstock can include a mixed Nd—Pr oxide, which is sometimes used to make cheaper low-grade rare-earth magnets. Scrap magnets of this type can be used as a feedstock in some examples. The feedstock can also include a rare earth metal hydroxide. For example, Nd₂O₃ can react with moisture to form Nd(OH)₃. This hydroxide can be used as a feedstock without any changes to the processes described herein, because the Nd hydroxide will calcine at around 500° C. back to the oxide form and the process will continue as described herein. Similarly, rare earth metal carbonates such as Nd₂(CO₃)₃ can be used as feedstocks, as these carbonates can also calcine back to the oxide form during the process. In another example, rare earth metal oxalates such as neodymium oxalate can be used. Complementary hydroxides, carbonates, and oxalates for each of the listed rare earth metals can also be used.

In further detail regarding the operations that make up the methods described herein, in some examples the method can include an initial hydrogenation operation before mixing the feedstock with the dissolution agent which comprises magnesium. The initial hydrogenation operation can be useful when the feedstock contains rare earth metal in a metallic form, as opposed to an oxide form. In the initial hydrogenation operation, the feedstock material can be exposed to a hydrogen atmosphere and heated to an elevated temperature to convert at least a portion of rare earth metal in the feedstock to a rare earth metal hydride prior to the magnesium dissolution step.

The elevated temperature used during the initial hydrogenation operation can be from about 560° C. to about 850° C. in some examples. In further examples, the elevated temperature can be from about 560° C. to about 800° C., or from about 560° C. to about 700° C., or from about 560° C. to about 670° C., or from about 700° C. to about 850° C., or from about 800° C. to about 850° C. In other examples, the elevated temperature can be below the melting point temperature of the rare earth metal in the feedstock.

In certain examples, the initial hydrogenation operation can include ramping up the temperature to the elevated temperature. The ramp rate can be from about 1° C. per minute to about 20° C. per minute, or from about 1° C. per minute to about 10° C. per minute, or from about 5° C. per minute to about 20° C. per minute, or from about 5° C. per minute to about 15° C. per minute, or from about 5° C. per minute to about 10° C. per minute. The temperature can be ramped up to the elevated temperature and then held at the elevated temperature for a hold time. Alternatively, the temperature can be ramped up to a higher temperature above the elevated temperature, and then the feedstock can be allowed to cool back down to the elevated temperature to be held at the elevated temperature for a hold time. In some examples, the hold time can be from about 30 minutes to about 24 hours, or from about 30 minutes to about 12 hours, or from about 30 minutes to about 8 hours, or from about 30 minutes to about 4 hours, or from about 1 hour to about 4 hours, or from about 2 hours to about 4 hours.

After the initial hydrogenation operation is performed, the feedstock can have an increased concentration of rare earth metal hydride compared to an initial concentration. In some examples, the feedstock can initially be substantially devoid of rare earth metal hydride. After the initial hydrogenation operation, some or all of the rare earth metal in the feedstock can be converted to a hydride. In certain examples, the fraction of rare earth metal in the feedstock that is converted to hydride can be from about 10% to about 100%, or from about 20% to about 100%, or from about 40% to about 100%, or from about 60% to about 100%, or from about 80% to about 100%, or from about 90% to about 100%.

The methods described herein can also include an initial comminution operation. This operation can be useful whenever the feedstock has a larger than desired particle size before beginning the method. In some examples, the feedstock can include a recycled material, a waste material, or a scrap material that includes a rare earth metal in metallic form. If the initial hydrogenation operation is used as described above, then in some cases the formation of rare earth metal hydride at grain boundaries can cause the feedstock material to break apart into small particles. Some additional mechanical crushing, milling, grinding or other processes can also be used to further break the material into small particles. Otherwise, such mechanical comminution processes can be used for any type of feedstock material to break the feedstock material into small particles. In some examples, the feedstock material can be a rare earth metal oxide or an ore that includes a fraction of rare earth metal oxide. These feedstock materials can also be broken into small particles by an initial comminution step. However, in some examples, the feedstock can be acquired in a particulate form and no initial comminution operation may be performed.

The feedstock material can be in a particulate form before the dissolution with a dissolution agent. In some examples, the feedstock can have an average particle size from about 10 micrometers to about 1 centimeter. In further examples, the average particle size can be from about 100 micrometers to about 5 millimeters, or from about 100 micrometers to about 3 millimeters, or from about 100 micrometers to about 1 millimeter.

The feedstock can be mixed with a dissolution agent which comprises magnesium, and the mixture can be heated to an elevated temperature to form a rare earth metal-magnesium alloy. This operation can be referred to as the operation of heating the feedstock with a dissolution agent. In some cases, this operation can also be referred to as a reduction operation, particularly when the feedstock includes rare earth metal oxides that are being reduced by the dissolution agent. In further examples, this operation can be referred to as a magnesium extraction or magnesium dissolution operation (e.g. solution and reprecipitation). This can describe the operation when the feedstock includes a rare earth metal in metallic form, because the rare earth metal can dissolve in molten magnesium and be extracted from the other components that may be present in the feedstock material. Additionally, the elevated temperature used during this operation can also be referred to as a reduction temperature.

The dissolution agent can include magnesium metal, magnesium hydride (MgH₂), or a combination thereof. The amount of dissolution agent added to the feedstock material can depend on the amount of rare earth metal in the feedstock material and whether the rare earth metal is in the form of an oxide or in a metallic form. When the feedstock includes a rare earth metal oxide, the dissolution agent also acts to reduce rare earth metal oxide. Thus, a sufficient amount of dissolution agent should be added to reach a desired level of reduction of the rare earth metal oxide and also dissolution of the reduced rare earth metal. In some examples, the amount of dissolution agent can be greater than a stoichiometric amount for the reaction of the dissolution agent with the oxygen atoms in the rare earth metal oxide. For example, in the reaction of Nd₂O₃ with Mg to form MgO, the stoichiometric ratio is 3 Mg atoms for every 2 Nd atoms, or an atom ratio of 1.5 for Mg to Nd. However, in practice the reduction may proceed only slightly if a stoichiometric amount of the dissolution agent is used. In some examples, the atom ratio of dissolution agent to rare earth metal in the alloying operation can be from about 3 to about 100, or from about 5 to about 100, or from about 10 to about 100, or from about 25 to about 75, or from about 25 to about 50, or from about 50 to about 75, or from about 50 to about 100. The weight ratio of magnesium to rare earth metal oxide can depend on the atomic weight of the particular rare earth metal. In some examples, the weight ratio of dissolution agent to rare earth metal oxide can be from about 3 to about 30, or from about 3 to about 20, or from about 5 to about 20, or from about 5 to about 15, or from about 5 to about 10.

When the feedstock does not include a rare earth metal oxide, then a smaller amount of dissolution agent may be sufficient. However, unused magnesium can be recycled in the methods described herein. Therefore, there is little downside to using an excess of magnesium as a dissolution agent. The magnesium mixed with the feedstock can form a rare earth metal-magnesium alloy during this operation. The magnesium can also ensure that the rare earth metal is not oxidized during this operation, because if any rare earth metal oxide forms then it can be reduced by the magnesium, forming MgO.

In any of the described configurations, the elevated temperature used to heat the mixture of the feedstock and dissolution agent can be from about 560° C. to about 850° C. in some examples. In further examples, the elevated temperature can be from about 560° C. to about 800° C., or from about 560° C. to about 700° C., or from about 560° C. to about 670° C., or from about 700° C. to about 850° C., or from about 800° C. to about 850° C. In further examples, the elevated temperature can be above a melting point temperature of an alloy formed between the rare earth metal and magnesium. Thus, a liquid rare earth metal-magnesium alloy can form during this operation. In further examples, the elevated temperature can be below a melting point of one or more other components present in the feedstock. This can allow some other components in the feedstock to be separated out as solid waste material.

In further examples, for both the dissolution and the hydride precipitation, the temperature can vary from as high as 1091° C. (which is the boiling point of Mg) or 1100° C. (which is the melting point of Nd) to as low as 180° C. The low range of temperatures can be achieved by adding alloying elements that lower the melting point of the Mg—Nd alloy produced through dissolution. These alloying elements can include Al, Na, Zn, Sn, or any other element that produces a low-melting eutectic with Mg. For example, Mg—Sn can have a eutectic melting point of about 200° C.

The dissolution operation can form a molten Mg—Nd alloy when performed at high temperatures, or a Mg—Nd solid solution and intermetallic compounds when performed at lower temperatures. Examples of Mg—Nd intermetallic compounds that can form include Mg₄₁Nd₅ and Mg₁₂Nd. In some cases, a Mg—Nd alloy can be formed with deposited pockets of intermetallic compounds. In these cases, the intermetallics can be dissolved during precipitation as Nd is removed from the alloy phase by hydride precipitation.

In certain examples, the operation of heating the mixture of the feedstock with the dissolution agent can include ramping up the temperature to the elevated temperature. The ramp rate can be from about 1° C. per minute to about 20° C. per minute, or from about 1° C. per minute to about 10° C. per minute, or from about 5° C. per minute to about 20° C. per minute, or from about 5° C. per minute to about 15° C. per minute, or from about 5° C. per minute to about 10° C. per minute. The temperature can be ramped up to the elevated and then held at the elevated temperature for a hold time. Alternatively, the temperature can be ramped up to a higher temperature above the elevated temperature, and then the feedstock can be allowed to cool back down to the elevated temperature to be held at the elevated temperature for a hold time. In some examples, the hold time can be from about 30 minutes to about 24 hours, or from about 30 minutes to about 12 hours, or from about 30 minutes to about 8 hours, or from about 30 minutes to about 4 hours, or from about 1 hour to about 4 hours, or from about 2 hours to about 4 hours.

A fluxing agent can optionally be added during this operation to capture impurities and/or adjust melting temperature of the molten dissolution agent. The fluxing agent can include a halide salt, a borate-based flux, or a combination thereof. Some specific examples of fluxing agents can include CaCl₂, CaBr₂, CaI₂, MgCl₂, MgBr₂, MgI₂, NaBr, NaI, KCl, KBr, KI, lithium tetraborate, lithium metaborate, sodium tetraborate, and others. In certain examples, the flux used in the methods described herein can be CaCl₂. The amount of flux added can be greater than the amount of rare earth metal in the feedstock in some examples. In certain examples, the amount of flux can be greater than the amount of rare earth metal in terms of atoms. In further examples, the amount of flux can be greater than the amount of rare earth metal in terms of weight. For example, a ratio of fluxing agent molecules to rare earth metal atoms in the alloying operation can be from about 3 to about 100, or from about 5 to about 100, or from about 10 to about 100, or from about 25 to about 75, or from about 25 to about 50, or from about 50 to about 75, or from about 50 to about 100. The weight ratio of the fluxing agent to rare earth metal oxide or metallic rare earth metal can depend on the atomic weight of the particular rare earth metal and the particular fluxing agent. In some examples, the weight ratio can be from about 3 to about 30, or from about 3 to about 20, or from about 5 to about 20, or from about 5 to about 15, or from about 5 to about 10. In further examples, a weight ratio of the fluxing agent to the dissolution agent can be from about 1:4 to about 4:1, or from about 1:3 to about 3:1, or from about 1:2 to about 2:1, or from about 3:5 to about 5:3.

In some examples, the mixture of the dissolution agent with the feedstock and optionally a fluxing agent can be heated under an inert atmosphere, such as argon. If an inert atmosphere is used, the product of this operation can include a rare earth metal-magnesium alloy without any rare earth metal hydride. In other examples, a hydrogen atmosphere can be used during this operation. If a hydrogen atmosphere is used, then at least a portion of the rare earth metal can be converted to rare earth metal hydride. Without being bound to a specific mechanism, in some cases the rare earth metal can form an alloy with the magnesium first, and then the rare earth metal can react with hydrogen to form the rear earth metal hydride. If the feedstock includes a rare earth metal oxide, then the oxide can be reduced by the magnesium in the dissolution agent to form MgO and rare earth metal in a metallic state. In those instances, a portion of the magnesium acts as a reducing agent and a portion acts as a dissolution agent to form an alloy. The rare earth metal can form an alloy with the excess magnesium present, and then the rare earth metal can react with hydrogen to be converted to the rare earth metal hydride. Depending on the atmosphere used and other factors, the product of this operation can include rare earth metal that is entirely in the form of a rare earth metal-magnesium alloy, or that is entirely in the form of rare earth metal hydride, or a combination of these. In some examples, an argon atmosphere can be used for part of the operation and a hydrogen atmosphere can be used for part of the operation.

Waste materials can be separated from the rare earth metal during this operation. In particular, waste materials can be separated from the molten rare earth metal-magnesium alloy. In some examples, waste materials can be removed as slag with the fluxing agent. In a particular example, the feedstock can include NdFeB magnets, and the waste materials removed can include Fe and B. Additionally, if an initial hydrogenation operation was performed then the rare earth metal can be at least partially in the form of a hydride at the beginning of this operation. The hydrogen can be removed as H₂ gas when the rare earth metal hydride converts to metallic rare earth metal and forms an alloy with magnesium during this operation. The waste materials can also include MgO, which can form when the feedstock includes rare earth metal oxide that is reduced by a portion of the magnesium in the dissolution agent.

The next operation in the methods described herein can include exposing the rare earth metal-magnesium alloy to hydrogen gas to convert the rare earth metal in the alloy to a rare earth metal hydride. This operation can also be referred to as a hydrogenation operation or a precipitation operation. The rare earth metal hydride can have a higher melting point than the rare earth metal-magnesium alloy, and therefore the rare earth metal hydride can precipitate as solid crystals from the molten alloy. This process, along with the following dehydrogenation operation, can allow the rare earth metal to be separated from magnesium much more easily than previously used vacuum distillation processes. In some cases, hydride precipitation can be performed sequentially after dissolution. Alternatively, hydride formation can be performed at least partially contemporaneously with dissolution (i.e. in whole or in part). For example, a hydrogen containing atmosphere can be introduced at the beginning of the dissolution and alloying, or during the alloying step such that hydride formation can occur contemporaneously with dissolution and alloying over the entire alloying step, or a portion thereof. In some cases, hydride precipitation can continue to occur subsequent to complete dissolution of rare earth metal and alloying. In this manner, dissolution and alloying, and hydride precipitation can be performed as a continuous or semicontinuous combined step. The methods described herein can take advantage of the melting point difference between the rare earth metal hydride and the rare earth metal-magnesium alloy, as well as the density difference between these species, to mechanically separate out the rare earth metal hydride.

The hydrogenation operation can be performed under a hydrogen atmosphere. Additionally, in some examples, hydrogen gas can be blown or bubbled through the molten rare earth metal-magnesium alloy to increase the surface area of contact between the hydrogen and the rare earth metal. This can increase the reaction rate and allow all of the rare earth metal in the molten alloy to contact hydrogen, instead of only at the surface. In further examples, a portion of the hydrogenation operation can be performed under an argon atmosphere and a portion can be performed under a hydrogen atmosphere. In certain examples, an argon atmosphere can be used during a ramp up of the temperature, and then the atmosphere can be switched to hydrogen when the hydrogenation temperature is reached.

The hydrogenation operation can also be performed at an elevated temperature. This temperature can be referred to as a hydrogenation temperature. In some examples, the hydrogenation temperature can be above the melting point of the rare earth metal-magnesium alloy so that the alloy is in a liquid state during the operation. The hydrogenation temperature can be below a melting point of the rare earth metal hydride so that the hydride is a solid during the operation. In certain examples, the hydrogenation temperature can be from about 560° C. to about 1100° C., or from about 560° C. to about 850° C. In further examples, the hydrogenation temperature can be from about 560° C. to about 800° C., or from about 560° C. to about 700° C., or from about 560° C. to about 670° C., or from about 650° C. to about 675° C., or from about 675° C. to about 700° C., or from about 700° C. to about 850° C., or from about 800° C. to about 850° C.

The Gibb's free energy of the rare earth metal hydride decreases as temperature decreases. Therefore, the formation of the rare earth metal hydride becomes more thermodynamically favorable at lower temperatures. Accordingly, using lower temperatures during the hydrogenation operation can be useful. In some examples, a Mg—Nd alloy can be heated to a temperature from 560° C. (which is the Mg—Nd eutectic melting point) up to 1100° C. (which is the melting point of Nd). In further examples, additional alloying elements can be added to the Mg—Nd alloy to reduce the melting point of the alloy. In such examples, the temperature during the hydrogenation operation can be as low as 180° C. The alloying elements can include Al, Ca, Li, Na, Zn, Sn, or any other element that produces a low-melting eutectic with Mg.

In certain examples, the hydrogenation operation can include ramping up the temperature to the hydrogenation temperature. The ramp rate can be from about 1° C. per minute to about 20° C. per minute, or from about 1° C. per minute to about 10° C. per minute, or from about 5° C. per minute to about 20° C. per minute, or from about 5° C. per minute to about 15° C. per minute, or from about 5° C. per minute to about 10° C. per minute. The temperature can be ramped up to the hydrogenation temperature and then held at the hydrogenation temperature for a hold time. Alternatively, the temperature can be ramped up to a higher temperature above the hydrogenation temperature, and then allowed to cool back down to the hydrogenation temperature to be held at the hydrogenation temperature for a hold time. In some examples, the hold time can be from about 30 minutes to about 24 hours, or from about 30 minutes to about 12 hours, or from about 30 minutes to about 8 hours, or from about 30 minutes to about 4 hours, or from about 1 hour to about 4 hours, or from about 2 hours to about 4 hours.

A fluxing agent can also be added during the hydrogenation operation. The fluxing agent can be any of the same fluxing agents described above. The fluxing agent added during the dehydrogenation operation can be added in a similar amount to the alloying operation. For example, a ratio of fluxing agent molecules to rare earth metal atoms in hydrogenation operation can be from about 3 to about 100, or from about 5 to about 100, or from about 10 to about 100, or from about 25 to about 75, or from about 25 to about 50, or from about 50 to about 75, or from about 50 to about 100. The weight ratio of the fluxing agent to rare earth metal can be from about 3 to about 30, or from about 3 to about 20, or from about 5 to about 20, or from about 5 to about 15, or from about 5 to about 10.

The methods described herein can also include a separation operation in which the rare earth metal hydride formed during the hydrogenation operation is separated from the magnesium. In some examples, substantially all of the rare earth metal that was present in the rare earth metal-magnesium alloy can be converted to rare earth metal hydride. The separation operation can include heating these materials to a temperature above the melting point of magnesium but below the melting point of the rare earth metal hydride. This temperature can be any of the temperatures described above for the hydrogenation operation. In some examples, the separation and the hydrogen operation can take place concurrently. For example, solid crystals of rare earth metal hydride can precipitate during the hydrogenation operation. These crystals can be separated from the rare earth metal-magnesium alloy while the reaction to convert more rare earth metal to hydride is still progressing. In other examples, the hydrogenation operation can be performed to completion without separating the rare earth metal hydride from the magnesium. The separation can then occur as a separate, later operation. In a particular example, the rare earth metal hydride and magnesium can be cooled after the hydrogenation operation, and then these materials can be heated again during the separation operation to melt the magnesium in order to separate the rare earth metal hydride. A hydrogen atmosphere can still be used during the separation operation, to ensure that the rare earth metal hydride does not convert back to the rare earth metal-magnesium alloy. The temperatures and hold times used for the separation operation can be similar to those used for the hydrogenation operation.

In a particular example, the hydride precipitation operation and separation of the hydride from the magnesium can be performed together. In this example, the Mg—Nd alloy formed during the alloying and reduction operation can be heated until molten. In a certain example, the temperature used to melt the alloy can be about 675° C. As an example, the alloy can be heated to this temperature under an Ar atmosphere or another inert atmosphere until molten, and then the atmosphere can be switched to 100% H₂. However, the atmosphere may also be switched to a hydrogen-containing atmosphere having less than 100% H₂ (i.e. down to hydrogen partial pressures of about 0.1 atm). For example, a hydrogen atmosphere of from 10% to 99%, 20% to 95%, or 50% to 85% can be used. Under H₂, NdHₓ forms at the interface between the molten metal and the gas in the reactor. In one example, a molybdenum paddle can be inserted into the molten alloy and rotated. This can cause the NdHₓ to be deposited on the paddle as it forms, allowing the NdHₓ to accumulate on the paddle for as long as is desired. The paddle can then be removed, and the reactor can then be allowed to cool. The NdHₓ can be removed from the paddle and dehydrogenated as previously described. Without being bound to a particular mechanism, the reason for the accumulation of Nd hydride on the paddle appears to be due to the paddle scraping the Nd hydride off the surface as it forms, or the molybdenum of the paddle can provide preferential sites for Nd hydride nucleation and growth, or a combination of these may occur. In some examples, it may be beneficial to protect the paddle material. In further examples, other materials besides molybdenum can be used to separate the Nd hydride from the molten Mg.

The rare earth metal hydride that was separated from the molten magnesium can be dehydrogenated in a dehydrogenation operation. In some cases, the rare earth metal hydride can be a desired intermediate product. However, typical commercial uses utilize the rare earth metal rather than the hydride. Regardless, in some cases, some small amounts of magnesium may remain in the rare earth metal hydride at this point. Therefore, in some examples, an optional magnesium removal operation can be performed before the dehydrogenation operation. In this magnesium removal operation, the rare earth metal hydride can be heated to an elevated temperature at which magnesium has a significant vapor pressure. A hydrogen atmosphere can be applied during this operation to ensure that the rare earth metal hydride does not become dehydrogenated and form an alloy with the magnesium, which would make it more difficult to remove the magnesium.

The temperature used during the magnesium removal operation can be from about 560° C. to about 1050° C. in some examples. In further examples, the magnesium removal temperature can be from about 560° C. to about 1000° C., or from about 560° C. to about 900° C., or from about 560° C. to about 700° C., or from about 700° C. to about 1050° C., or from about 800° C. to about 1050° C., or from about 900° C. to about 1050° C.

In certain examples, the magnesium removal operation can include ramping up the temperature to the magnesium removal temperature. The ramp rate can be from about 1° C. per minute to about 20° C. per minute, or from about 1° C. per minute to about 10° C. per minute, or from about 5° C. per minute to about 20° C. per minute, or from about 5° C. per minute to about 15° C. per minute, or from about 5° C. per minute to about 10° C. per minute. The temperature can be ramped up to the magnesium removal temperature and then held at the magnesium removal temperature for a hold time. Alternatively, the temperature can be ramped up to a higher temperature above the magnesium removal temperature, and then the rare earth metal hydride can be allowed to cool back down to the magnesium removal temperature to be held at the magnesium removal temperature for a hold time. In some examples, the hold time can be from about 30 minutes to about 24 hours, or from about 30 minutes to about 12 hours, or from about 30 minutes to about 8 hours, or from about 30 minutes to about 4 hours, or from about 1 hour to about 4 hours, or from about 2 hours to about 4 hours. After the magnesium removal operation is complete, the rare earth metal hydride can be substantially free of magnesium.

The dehydrogenation operation can be similar to the magnesium removal operation, except that a non-hydrogen atmosphere can be used so that the rare earth metal hydride converts to metallic rare earth metal and the hydrogen is removed as H₂ gas. In some examples, the dehydrogenation operation can be performed under an inert atmosphere such as an argon atmosphere.

The temperature used during the dehydrogenation operation can be from about 760° C. to about 1100° C. in some examples. In further examples, the dehydrogenation temperature can be from about 760° C. to about 1050° C., or from about 760° C. to about 900° C., or from about 760° C. to about 800° C., or from about 800° C. to about 1050° C., or from about 900° C. to about 1050° C., or from about 900° C. to about 1100° C.

In certain examples, the dehydrogenation operation can include ramping up the temperature to the dehydrogenation temperature. The ramp rate can be from about 1° C. per minute to about 20° C. per minute, or from about 1° C. per minute to about 10° C. per minute, or from about 5° C. per minute to about 20° C. per minute, or from about 5° C. per minute to about 15° C. per minute, or from about 5° C. per minute to about 10° C. per minute. The temperature can be ramped up to the dehydrogenation temperature and then held at the dehydrogenation temperature for a hold time. Alternatively, the temperature can be ramped up to a higher temperature above the dehydrogenation temperature, and then the rare earth metal hydride can be allowed to cool back down to the dehydrogenation temperature to be held at the dehydrogenation temperature for a hold time. In some examples, the hold time can be from about 30 minutes to about 24 hours, or from about 30 minutes to about 12 hours, or from about 30 minutes to about 8 hours, or from about 30 minutes to about 4 hours, or from about 1 hour to about 4 hours, or from about 2 hours to about 4 hours. After the dehydrogenation operation is complete, the rare earth metal can be substantially free of hydrogen. The rare earth metal can also be substantially pure since magnesium and other materials were removed during the other operations of the method.

A fluxing agent can also be added during the dehydrogenation operation. The fluxing agent can be any of the same fluxing agents described above. In some examples, the fluxing agent can be added to the rare earth metal hydride at a weight ratio from about 1:4 to about 4:1, or from about 1:3 to about 3:1, or from about 1:2 to about 2:1, or about 1:1.

In some examples, the rare earth metal product can be at least about 95% pure, or at least about 97% pure, or at least about 99% pure, or at least about 99.9% pure. If multiple rare earth metals were present in the feedstock, then multiple rare earth metals may be present in the final product. These purity levels can refer to the total combined rare earth metals in such cases. In further examples, the rare earth metal can have an oxygen content of less than 2% by weight, or less than 1% by weight, or less than 0.5% by weight, or less than 0.1% by weight, or less than 0.01% by weight. The rare earth metal can also have a magnesium content of less than 2% by weight, or less than 1% by weight, or less than 0.5% by weight, or less than 0.1% by weight, or less than 0.01% by weight. The rare earth metal can also have an iron content of less than 2% by weight, or less than 1% by weight, or less than 0.5% by weight, or less than 0.1% by weight, or less than 0.01% by weight.

Additionally, the methods described herein can have a high mass yield, or the fraction of rare earth metal present in the product vs. the original feedstock. In some examples, at least 90% of the rare earth metal present in the feedstock can be present in the product. In further examples, the fraction can be at least 95%, at least 97%, at least 98%, or at least 99%.

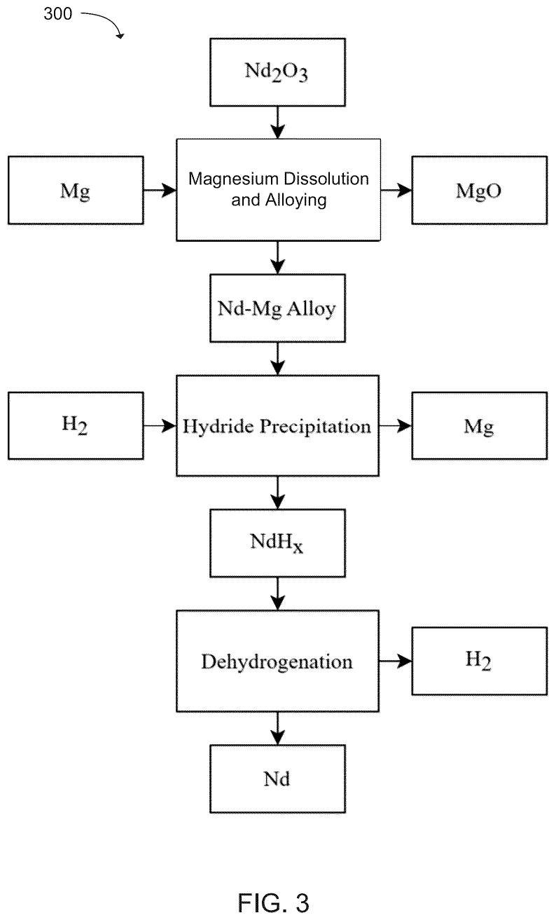

As non-limiting exemplary implementations of the above principles, several configurations for processes of producing rare earth metals using hydrogen augmented magnesium alloying are described in connection with FIGS. 3 through 7.

FIG. 3 is a flowchart showing an example method 300 of producing neodymium from Nd₂O₃. In this method, the feedstock material contains Nd₂O₃. The feedstock is subject to magnesium dissolution and alloying step, in which magnesium is added as a dissolution agent and the mixture is heated at a dissolution temperature where Nd₂O₃ is reduced and the resulting Nd is dissolved and then alloyed with magnesium. This dissolution and alloy formation step can be performed in the absence of a hydrogen atmosphere, an inert atmosphere, or in a hydrogen-containing atmosphere. This produces MgO as a byproduct and a Mg—Nd alloy containing the reduced Nd in metallic form. The Mg—Nd alloy is then subjected to hydride precipitation. In this step, hydrogen gas is added to convert the Nd in the molten alloy to NdHₓ. The NdHₓ can be separated as a solid from molten magnesium, leaving the magnesium metal without the Nd. Once NdHₓ is removed via precipitation, the molten magnesium can be cooled and then reused. The NdHₓ is then subjected dehydrogenation by heating the NdHₓ under vacuum or a non-hydrogen atmosphere. The hydrogen is given off as H₂ gas, and the product is metallic neodymium. Further details and variations of this process are described below.

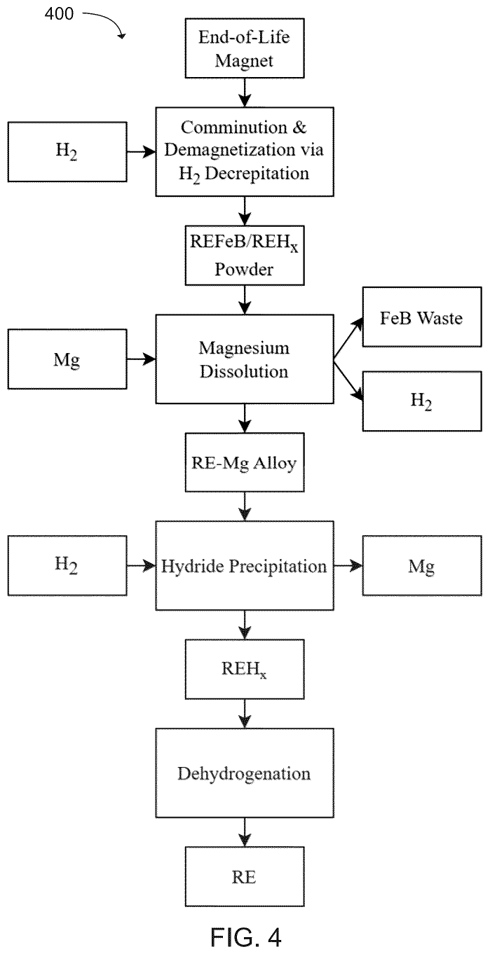

FIG. 4 is a flowchart of another example method 400 of producing metallic neodynium. In this method, the initial feedstock is an end-of-life magnet, which can also be referred to as a scrap magnet. The scrap magnet can contain a rare earth metal, such as an NdFeB magnet. The scrap magnet is subjected to a comminution and demagnetization operation by hydrogen decrepitation. The scrap magnet is exposed to a hydrogen atmosphere at an elevated temperature, which causes a Nd hydride to form at grain boundaries. This causes a volume expansion and breaks the magnet into powder while also demagnetizing the magnet. The powder is then subjected to a magnesium dissolution operation where the neodymium is subjected to dissolving in solution and then reprecipitation. In this operation, liquid magnesium is used to extract the neodymium from the powder. In the case of NdFeB magnets, the Nd can dissolve in the molten magnesium and form an alloy with the Mg, and the Fe and B components of the magnet can be separated out as solid waste. Neodymium hydride that formed during the comminution operation can also be dehydrogenated during this operation because the temperature during this operation can be above the decomposition temperature of the rare earth metal hydride. The hydrogen can form H₂ gas and the rare earth metal can go into the liquid alloy with magnesium. If any neodymium oxide is present, the magnesium can reduce the oxide and the reduced neodymium metal can dissolve into the molten neodymium-magnesium alloy.

The molten neodymium-magnesium alloy can be subjected to a hydride precipitation operation. This operation can separate the neodymium from the magnesium in the alloy. The alloy is exposed to hydrogen gas at a temperature above the melting point of the alloy, but below the decomposition temperature of the neodymium hydride. This can cause crystals of solid neodymium hydride to precipitate. The neodymium hydride can be denser than the liquid magnesium. The difference in density can be exploited to separate the hydride from the magnesium.

The method 400 can also include a dehydrogenation operation. After separating solid rare earth metal hydride from liquid magnesium, the neodymium hydride can be dehydrogenated by heating to a temperature above the melting point of magnesium under vacuum. Dehydrogenating at this temperature also has the effect of removing any minor residual magnesium due to its high vapor pressure when molten. The product of this operation can be the separated and purified rare earth content of the magnet material fed into the process, either as a powder or a solid depending on the dehydrogenation temperature. This metallic neodymium can then be used to make new magnets or other products.

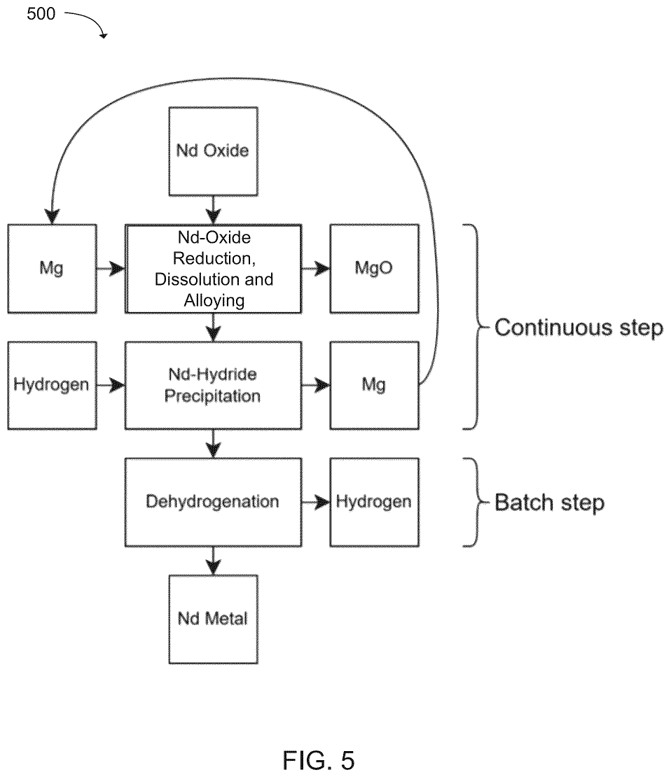

FIG. 5 is a flowchart illustrating another method 500 of producing metallic neodymium. In this example, the method begins with Nd oxide as the feedstock material. A dissolution operation can be performed by adding Mg and heating to a temperature above the melting point of magnesium, which reduces the Nd oxide and forms a Mg—Nd alloy and MgO as a side product. As a general guideline, the temperature can be any temperature above a melting temperature of the alloy. For example, Mg—Nd (without any additional elements added to lower the melting point) the temperature can be from 560-650° C. as a lower limit up while precipitation can generally be performed up to about 900° C. In some cases, temperatures above 900° C. may be used if the hydrogen pressure is increased above 1 atm. In some examples, the temperature can be lowered slightly between reduction and precipitation. A Nd hydride precipitation operation is then performed by exposing the Mg—Nd alloy to hydrogen gas. This causes Nd hydride to precipitate from the Mg—Nd alloy. The Nd hydride is removed, leaving Mg metal. The Mg metal can be recycled to be used in the Nd oxide reduction and alloying operation. As shown in this figure, the Nd oxide reduction operation and the Nd hydride precipitation operation can be performed continuously in some examples. After separating the Nd hydride, the Nd hydride can go through a dehydrogenation operation. The hydrogen is removed as hydrogen gas, and the final product is Nd metal. As shown in this figure, the dehydrogenation operation can be performed as a batch step. For example, a batch of Nd hydride can be heated under an inert atmosphere or vacuum to remove the hydrogen.

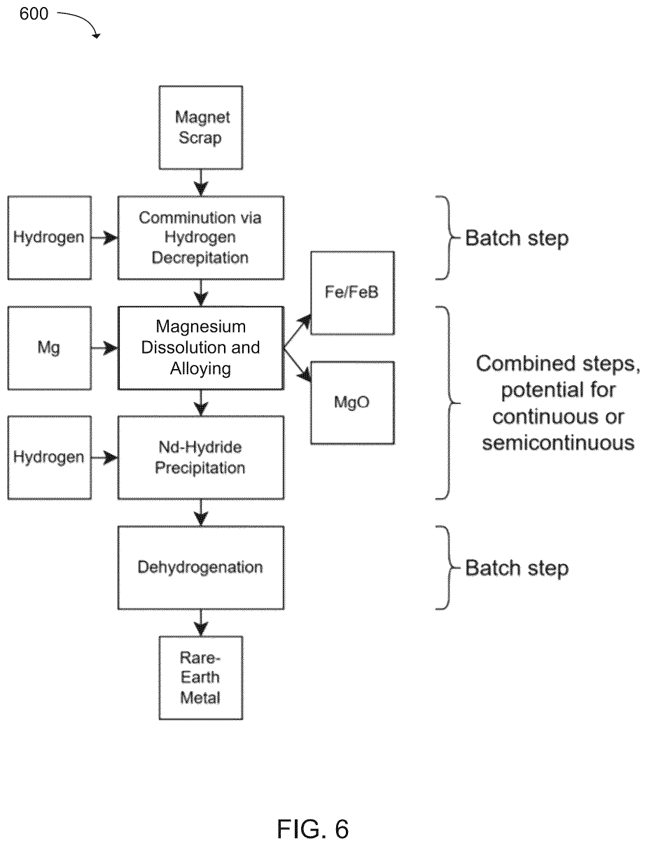

FIG. 6 is a flowchart illustrating another method 600 of producing metallic neodymium. In this example, the feedstock material is magnet scrap. Magnet scrap can also be referred to as waste magnets or end of life magnets. The magnet scrap is subjected to hydrogen decrepitation and comminution. As shown in this figure, this step can be performed as a batch step. For example, a batch of magnet scrap can be exposed to hydrogen to form brittle hydrides and then the magnet scrap can be crushed to form a powder containing Nd. The powder can then be subjected to a Nd dissolution and alloying operation by adding Mg and heating to a dissolution temperature which can reduce any Nd oxide and to allow formation of a Mg—Nd alloy. This alloying operation produces the Mg—Nd alloy, as well as MgO and Fe/FeB as side products. The Mg—Nd alloy is subjected to a Nd hydride precipitation operation by exposing the alloy to hydrogen to form Nd hydride. As shown in this figure, the alloying operation and the Nd hydride precipitation operation can be combined in a single step in which these operations are performed simultaneously. Additionally, the alloying operation and the Nd hydride precipitation operation can be performed continuously or semi-continuously. The Nd hydride can then be subjected to a dehydrogenation operation to form Nd rare earth metal as the final product. The dehydrogenation operation can be performed as a batch step. Specific temperatures and conditions for each step are described in more detail below.

Whether or not the Mg alloying step of reduction and dissolution can be operated continuously can depend on the management of MgO and Fe/FeB. Magnet scrap can be composed mainly of Nd₂Fe₁₄B. Molten Mg extracts the Nd from this material, producing Fe and a small amount of FeB. This Fe/FeB accounts for 70% of the weight of the scrap, so a significant amount is produced. This scrap can also be oxidized, which can cause some Mg to be consumed to produce MgO, which forms as a slag on the surface that can be scraped off. In some examples, a semi-continuous process can be used for this step. In one example, Mg can dissolve the Nd to form a molten alloy while the Fe/FeB settles to the bottom of the crucible. MgO can be scraped off the top of the melt pool and removed, and then hydrogen can be used to produce NdHₓ at the surface of the melt pool, which can be removed and stored. More magnet scrap can be added whenever the Nd becomes depleted through hydride precipitation. The Fe/FeB can build up in the crucible until no more scrap can be added, at which point the crucible can be cleaned before the process begins again. In further examples, this process can be performed continuously.

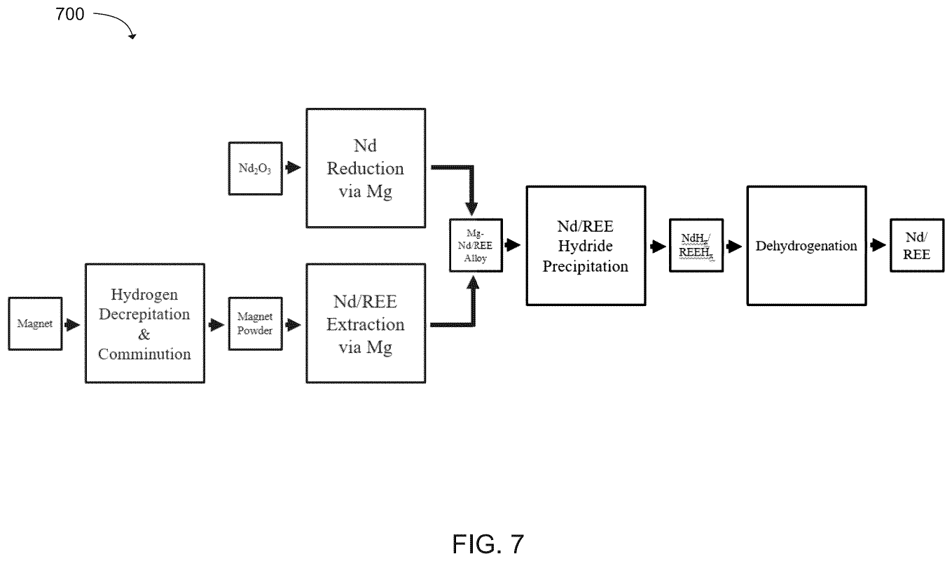

FIG. 7 is a flowchart illustrating another method 700 of producing metallic neodymium. This example combines the use of two different feedstocks. Nd oxide is one feedstock used in the process. The Nd oxide is reduced using Mg to form a Mg—Nd alloy. The other feedstock is magnet scrap (end of life magnets). The magnet scrap is subject to hydrogen decrepitation and comminution to make magnet powder as described previously. The magnet powder is comprised of Nd and possibly small amounts of other rare earth metals (“REE” in FIG. 7). The magnet powder is then subjected to Nd and rare earth element extraction using Mg. This also forms a Mg—Nd/REE alloy. The Mg—Nd alloy made from both types of feedstock material can be combined together and subjected to Nd and rare earth element hydride precipitation to form a Nd/rare earth element hydride. The hydride can then be dehydrogenated to form the final product, Nd metal and/or other rare earth elements.

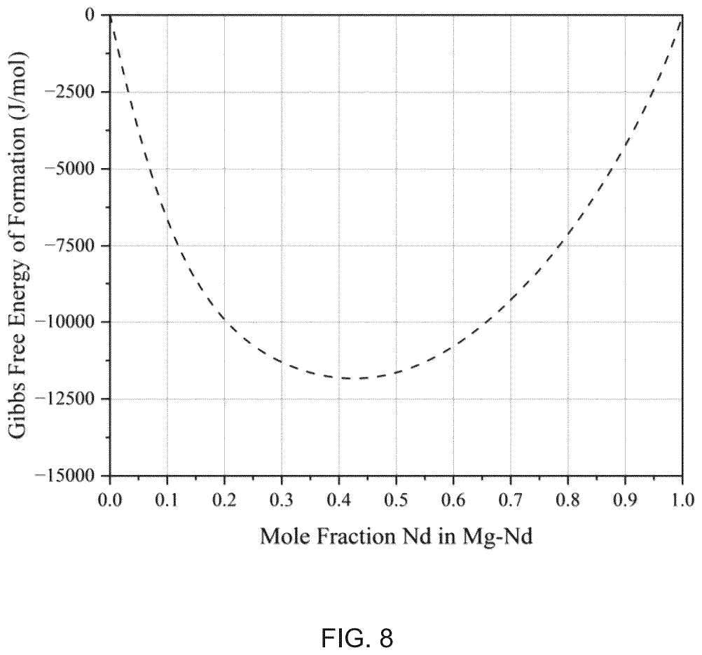

FIG. 8 is a graph of the Gibbs free energy of formation of Mg—Nd alloys at 707° C. across the range of mole fractions of Nd in the Mg—Nd alloys. As shown in the graph, the Gibbs free energy of formation decreases from 0.0 mole fraction of Nd up to about 0.4 mole fraction of Nd, and increases in the range of 0.4 to 1.0 mole fraction of Nd. The lower the Gibbs free energy of formation is, the easier it can be to reduce the Nd oxide by forming a Mg—Nd alloy. In some examples, the alloying operation described herein can form a Mg—Nd alloy that has a mole fraction of Nd from about 0.05 to about 0.2.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting.

### EXAMPLES

### Example 1

A method as described herein was used experimentally to reduce Nd₂O₃ to form Nd metal. The feedstock material was reagent-grade Nd₂O₃ from Thermo Scientific. Other materials included 40 mesh Mg powder and reagent-grade CaCl₂ from VWR Life Science. Dissolution, reduction, hydride precipitation, and dehydrogenation were performed in an Across International VTF1200 tube furnace with a Eurotherm 2404 temperature controller. Dissolution, reduction and hydride precipitation were performed in stainless steel crucibles. Dehydrogenation was performed in a molybdenum crucible. Regular purity Ar and H₂ were used for furnace atmosphere. X-ray diffraction (XRD) was performed using the Rigaku Miniflex 600. Scanning electron microscopy/energy dispersive spectroscopy (SEM/EDS) was performed using the FEI Quanta 600. Transmission electron microscopy (TEM) was performed using a JEOL JEM 2800. Samples for TEM were prepared via focused ion beam (FIB) with an FEI Helios Nanolab 650 FEG. Thermogravimetric analysis (TGA) was performed using a TA Instruments Q600. A simulated diffraction pattern of NdH₂ was generated with CrysTBox DiffractGUI software using CIF data from the Crystallography Open Database.

Dissolution and reduction was performed using four separate sets of conditions to test the differences that these conditions cause in the alloying operation. The variables included the atmosphere (argon or hydrogen) and the presence of a fluxing agent (calcium chloride). The four sets of conditions included: Mg+Nd₂O₃ in Ar or H₂, and Mg+Nd₂O₃+CaCl₂ in Ar or H₂. In the first condition, Nd₂O₃ was homogenously mixed with Mg metal in the mass ratio 1:4. This mixture was then heated in a stainless-steel crucible to 750° C. using a 10° C./min ramp rate for 6 hours in 100% H₂ or Ar atmosphere, after which the furnace was allowed to cool. In the case where CaCl₂ was used, Nd₂O₃ was mixed with Mg metal and CaCl₂ in the ratio 1:4:4 (by mass) and heated to 800° C. for 40 minutes again using a 10° C./min ramp rate, then allowed to cool to 750° C. where it was held for an additional 6 hours before the furnace was allowed to cool. In the Ar atmosphere case, Mg reduces Nd₂O₃ via the following reaction:

3Mg+Nd₂O₃→3MgO+2Nd (1)

Under H₂, the overall reaction for the reduction of Nd₂O₃ and formation of the non-stoichiometric neodymium hydride is written as:

3Mg+Nd₂O₃+xH₂→3MgO+2NdHₓ (2)

The hydride precipitation operation was performed using the Mg—Nd alloy produced via reduction with CaCl₂ under 100% Ar atmosphere as previously described. This Mg—Nd alloy was mixed with CaCl₂ in the ratio of 1:0.5 by mass, then heated under 100% Ar at L/min to 800° C. for 40 minutes using a 10° C./min ramp rate, at which point the gas was switched to 100% H₂ at L/min and temperature was decreased linearly to 650° C. over the next 6 hours, after which the furnace was allowed to cool. H₂ flow was maintained until the sample cooled to room temperature.

NdHₓ was isolated from Mg by heating Mg—Nd alloy produced via reduction and dissolution to 850° C. under 100% H₂ atmosphere flowing at 2 L/min for 8 hours. This NdHₓ was mixed with CaCl₂ in a 1:1 ratio and converted to Nd at 1050° C. in a molybdenum crucible under 100% Ar atmosphere flowing at 2 L/min for 2 hours. The NdHₓ decomposes via the following reaction:

2NdHₓ→2Nd+xH₂ (3)

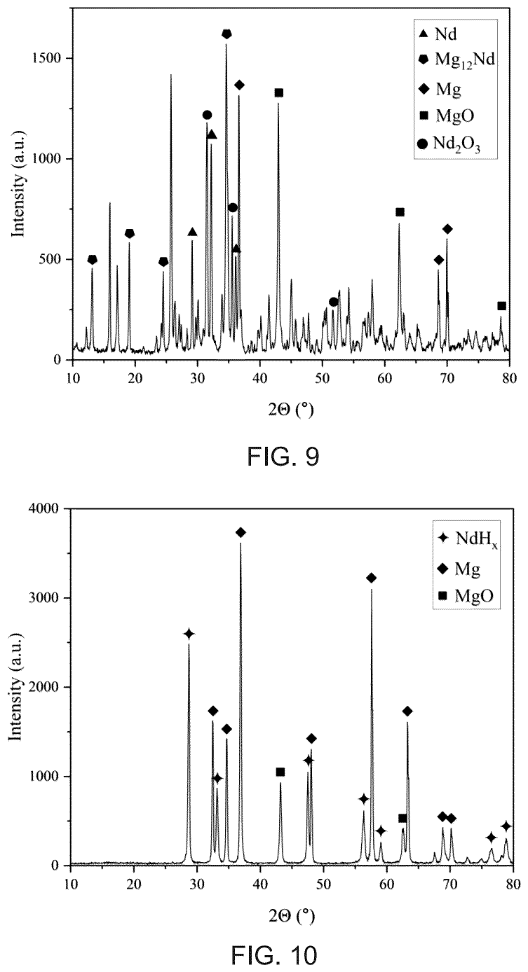

The results of the experimental operations will now be described. In the sample that utilized an argon atmosphere during dissolution and reduction, the product after dissolution and reduction consisted of a lightly bonded puck of mixed Nd/Mg metal and Nd/Mg oxide powder demonstrating partial reduction. The XRD spectra (FIG. 9) shows Mg metal, Nd metal, the Mg₁₂Nd intermetallic compound, as well as several significant peaks that do not match any of the Nd/Mg species in the database, which is likely the intermetallic compound Mg₄₁Nd₅. The presence of Nd₂O₃ in the spectra could be due to either incomplete reduction or reoxidation in the presence of air due to the high surface area of the sample. Reoxidation is more likely, since the amount of Mg used in reduction is around eighteen times the stoichiometric amount, and this can be enough to achieve near-complete reduction, as will be discussed below regarding the thermodynamic modelling the reduction reaction. In the case of reduction under hydrogen, the product consisted of MgO, Mg, and NdHₓ. The XRD spectra for the sample reduced under hydrogen is shown in FIG. 10. The lack of Nd₂O₃ peaks in the XRD spectra suggests both that reduction is complete, and that if reoxidation is the reason for Nd₂O₃ peaks in the non-H₂ reduction, that NdHₓ is more stable in air than Nd/Mg—Nd intermetallic compounds. During peak matching, some shifting of NdHₓ peaks was observed compared to the NdH₂ pattern in the database, suggesting that the neodymium hydride being formed is a nonstoichiometric compound NdHₓ with x>2, which would cause the unit cell to expand, thus causing the shift.

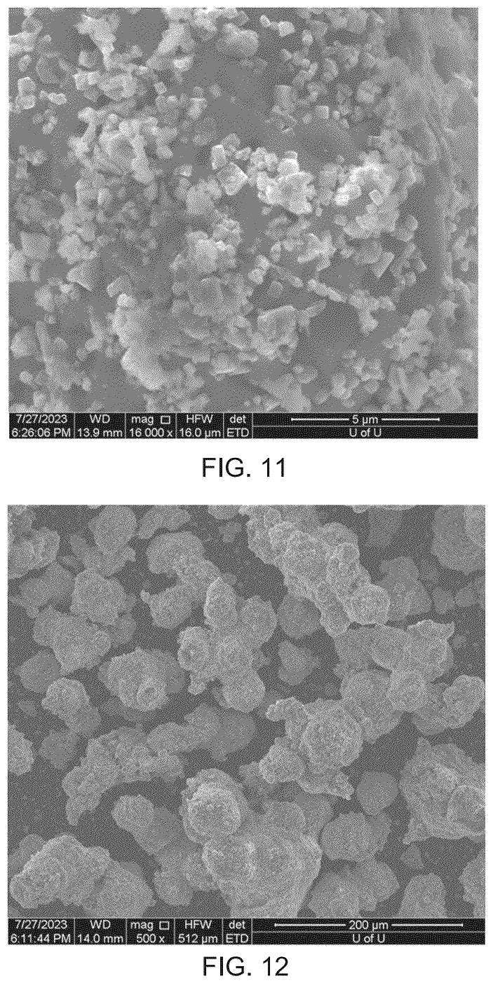

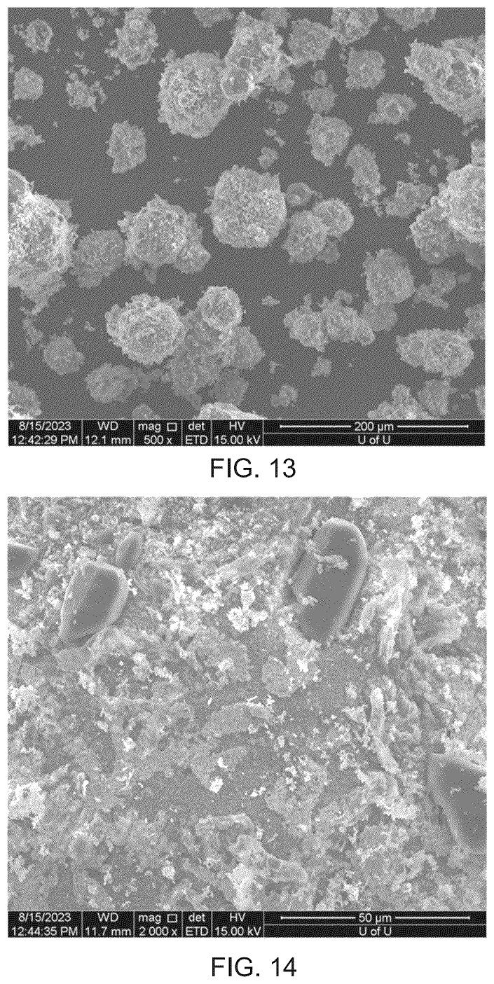

SEM/EDS was also performed on these samples after the reduction operation to examine the morphology of the reduction products. Looking at the SEM micrographs (FIGS. 11-14) of the product from reduction under H₂, there were large spherical particles of Mg coated with smaller faceted Mg particles, as well as brighter NdHₓ patches and small MgO particles. Wet chemistry techniques cannot be used to remove these oxide particle or separate NdHₓ from its Mg matrix because NdHₓ will oxidize rapidly on contact with water. The challenge of separating the formed NdHₓ from Mg/MgO led to the use of CaCl₂ as a flux to allow for better separation of reduction products. CaCl₂ can be inert with respect to Mg and MgO, however it has been found to react with Nd₂O₃, forming either NdCl₃ or NdOCl and producing CaO in the process. The lack of CaO in the reduction product suggests that these reactions are not occurring, probably due to Nd₂O₃ being consumed during reduction at a lower temperature before the chloride/oxychloride can form. Dissolution and reduction with flux under Ar resulted in small (1-5 mm) spherical particles of an Mg—Nd alloy phase dispersed throughout an MgO—CaCl₂ slag phase. SEM/EDS was done on both phases to assess the extent of reduction and evaluate the concentration of Nd in the Mg—Nd alloy.

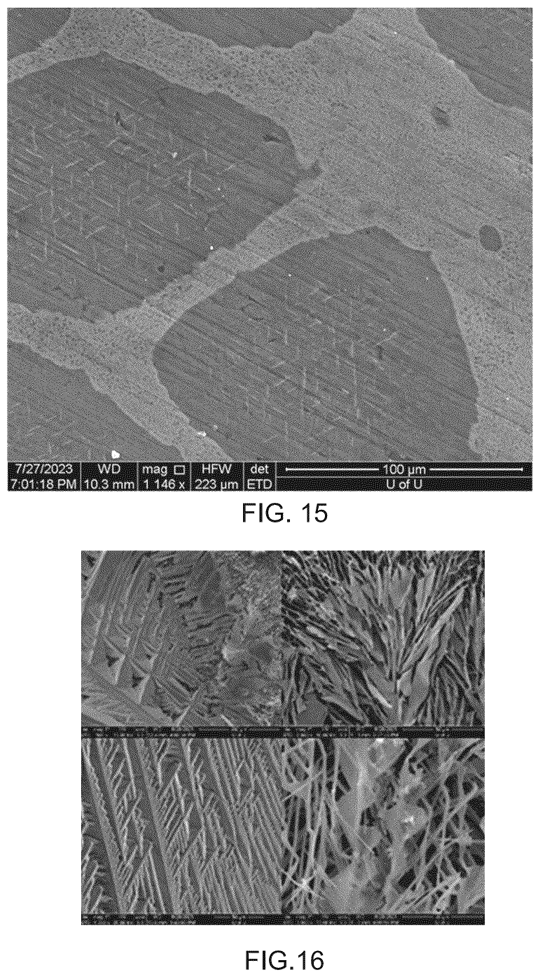

The Mg—Nd alloy possessed a three-phase microstructure consisting of an Mg phase containing a small amount of dissolved Nd in addition to an Mg₄₁Nd₅ intermetallic phase that likely formed during cooling along the grain boundary, along with intragranular Widmanstätten plates. Nd₂O₃ is undetectable in the slag phase, suggesting that reduction was complete even in the absence of H₂. In the case of reduction under H₂ atmosphere, the same metal and slag phases formed, however the small particles of Mg—Nd had coalesced into one large piece, and NdHₓ crystals ranging from purple to golden in color had grown on the surface of the Mg—Nd alloy phase. FIG. 15 is the SEM micrograph showing the Mg—Nd alloy.

NdHₓ is a non-stoichiometric compound of neodymium and hydrogen with FCC crystal structure, where x ranges from 2-3. For NdH₂, hydrogen occupies the octahedral sites of the FCC lattice, however it is able to absorb more hydrogen in the tetrahedral lattice sites, allowing for ratios of H:Nd approaching just less than three. The exact ratio of hydrogen to neodymium depends on the temperature and H₂ pressure it forms under. In some cases, the ratio can approach 3 when cooling is done slowly under a hydrogen atmosphere. Precipitation of NdHₓ from Mg—Nd alloy was carried out in a tube furnace in 100% H₂ atmosphere. It has been observed that surface oxidation even on sanded and polished Mg—Nd alloy prevents formation of large NdHₓ crystals. To avoid this, CaCl₂ was used as a flux to clean the surface of the molten Mg—Nd pool. Maximum temperature was 800° C. in order to melt CaCl₂, then temperature was allowed to decrease to the 650° C. (the melting point of Mg) over the course of six hours, resulting in the precipitation of large crystals of NdHₓ, with the largest being up to 1 cm in length. Stability of NdHₓ in air decreases as the H:Nd ratio increases, suggesting that the hydrides formed in these conditions are close to the stoichiometric formula NdH₂ as they were stable in air for multiple months without visibly oxidizing. The morphology of the precipitated NdHₓ ranged from large blunt points at the macro-scale, to dendritic and feather-like formations at the multiple micron scale, down to wire-like crystals at the single micron to nano-scale.

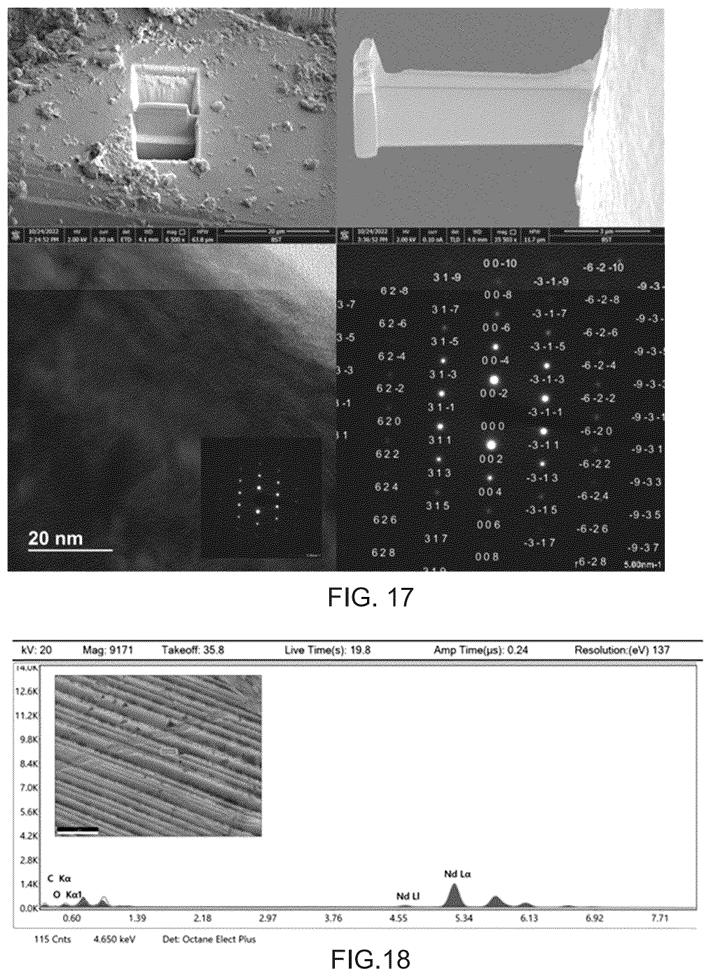

EDS of these crystals shows only Nd (FIG. 16), which is due to the inability of EDS to detect or quantify hydrogen. This time-temperature profile was chosen for two reasons: first, the optimal temperature for large crystal growth is unknown, however NdHₓ under H₂ appears stable at all temperatures used. The second reason is that experiments attempting NdHₓ precipitation for 3 hours at various temperatures under 100% H₂ flowing at L/min showed that precipitation of large well shaped crystals only occurred when Mg—Nd alloy was liquid, with NdHₓ forming only as a thin coating when hydrogenation was attempted below 650° C. This is likely due to initial formation of NdHₓ consuming all available Nd from near the H₂/Mg—Nd interface, with diffusion of additional Nd from the bulk being too slow in solid Mg to allow for large crystal growth within the 3 hours. For precipitation in the liquid phase, the NdHₓ layer attained a greater maximum thickness, but no further thickness increase was observed even when precipitation time was in excess of 12 hours. This is likely due to previously formed NdHₓ passivating the Mg—Nd surface and preventing further reaction. Due to the dissimilarity of the large colorful crystals formed in these experiments to previously reported appearance of NdHₓ (which is often described as black to graphite-like), as well as difficulty in separating the crystals from the alloy matrix, FIB and TEM BSED was used to confirm the identity of the hydride. The BSED pattern of NdH₂ simulated using CrysTBox with data from Crystallography Open Database shows excellent matching with the diffraction pattern obtained experimentally from the FIB sample, confirming that the species being precipitated is NdHₓ (FIG. 17).

The NdHₓ was converted to Nd metal by mixing it with CaCl₂ in a 1:1 ratio and heating at 1050° C. in a molybdenum crucible. First, the NdHₓ was heated under a hydrogen atmosphere to allow any remaining Mg to evaporate. At this temperature, Mg possesses significant vapor pressure, allowing it to evaporate off completely. Hydrogen atmosphere was selected to keep NdHₓ stable and prevent Nd from going into solution with Mg, which would raise its melting point and potentially prevent complete Mg removal. This resulted in a mixture of primarily NdHₓ with some MgO. Then, The NdHₓ was converted to Nd under 100% Ar atmosphere flowing at 2 L/min for 2 hours. NdHₓ will decompose to Nd around 750° C., however this temperature was selected because it was desired that Nd melt and form a single solid mass rather than sponge or powder. MgO contamination should not present a problem, as molten Nd metal will react with MgO to form Mg, which will vaporize. The resulting Nd₂O₃ will be fluxed by CaCl₂, allowing for separation of Nd metal from slag. Stainless steel was avoided when selecting the crucible material because at these temperatures Nd may react with iron, possibly melting it. This dehydrogenation condition resulted in a small amount of solid Nd metal adhered to the Mo crucible, which was removed and characterized with EDS (FIG. 18).

EDS results show that the only species present above the detection limit were Nd, C, and O. The lack of Mg, Ca, or Cl shows that NdHₓ precipitation followed by decomposition is selective for Nd. Carbon is likely being picked up from the sample holder, while oxygen is being picked up from the surface of the sample, due to the relative reactivity of Nd causing it to oxidize in air.

The Ellingham diagram shows that, under standard conditions, Mg is not a suitable reductant for Nd₂O₃ by the pathway of Equation (1) above. Despite this, the experimental results above achieved a reduction extent of nearly 100%. The result indicates there is a different reaction pathway for which the thermodynamics of the process is different from what is represented by Equation (1). The experimental results presented above showed that the reaction product of the reduction step is not simply Nd metal, but rather a Mg—Nd solid solution alloy and intermetallic compounds. The thermodynamics of this system were examined, starting with determining the equilibrium constant for the reduction reaction at 750° C.:

$$Δ G = Δ {G}_{750 C .}^{°} + RT ln Q \qquad ( 4 )$$

At equilibrium (ΔG=0), the reaction quotient Q is equal to the equilibrium constant K:

$$0 = Δ {G}_{750 C .}^{∘} + RT ln K \qquad ( 5 )$$

ΔG°_{750C}=45.226 kJ/mol is the standard free energy for reaction. The value of the equilibrium constant, K, at this temperature is determined to be 0.0049. The equilibrium constant can be used to determine the equilibrium concentration of reduced Nd in molten Mg at 750° C. by examining the reaction quotient Q.

$$3 Mg + N {d}_{2} {O}_{3} ↔ 3 M g O + 2 Nd \qquad ( 1 )$$

$$Q = \frac{{{[ MgO ]}^{3} [ Nd ]}^{2}}{{[ {Nd}_{2} {O}_{3} ] [ Mg ]}^{3}} \qquad ( 6 )$$

The activity of MgO and Nd₂O₃ are assumed to be unity, while the activities of Nd and Mg are approximated as their mole fraction (Xᵢ) in a liquid solution with one another.

$$0.0049 = \frac{{[ X ]}^{2}}{{[ 1 - X ]}^{3}} \qquad ( 7 )$$

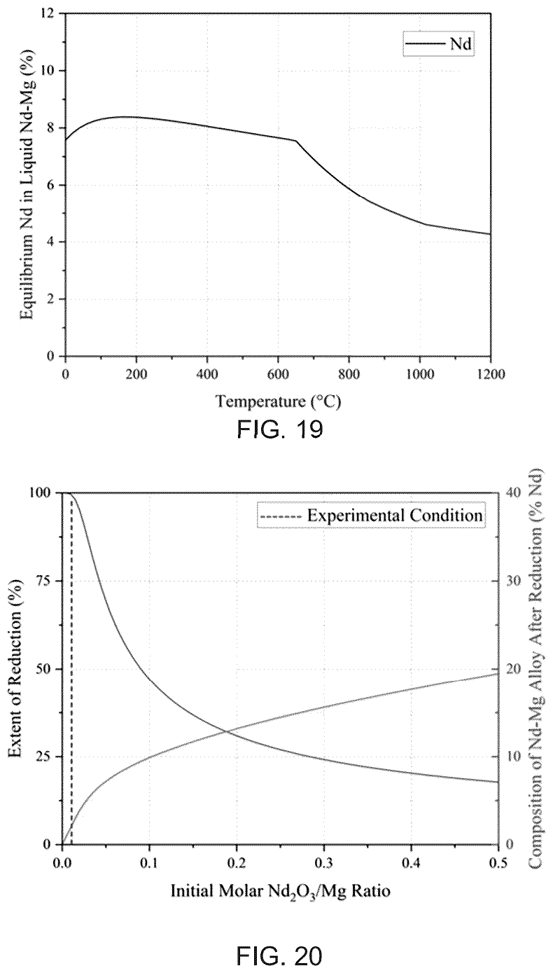

The value of the equilibrium mole fraction of Nd in Mg at this temperature is determined to be 0.064. This model implies the physical meaning of a pool of liquid Mg in contact with a large amount of both MgO and Nd₂O₃. The liquid Mg reduces and dissolves Nd until the equilibrium concentration of 6.4 at. % is achieved, at which point no further reduction takes place. FIG. 19 shows the plot of equilibrium mole fraction of Nd in solution vs. temperature, it can be seen that the value increases as temperature decreases. It also happens that the predicted equilibrium concentration is very close to the eutectic point of the Mg—Nd system (548° C. at 7.4 at. % Nd), meaning the liquid metal solution produced during reduction could stay liquid at temperatures nearing 550° C., well below the initial melting point of Mg.

This analysis does not take into consideration extent of reduction (the percentage of Nd₂O₃ converted to Nd). When reduction nears completion, activity of Nd₂O₃ may not be unity as assumed, and this is more likely to occur in situations where the initial ratio of Nd₂O₃ to Mg is quite small, as is the case in the experiments performed in this work, where eighteen times the stoichiometric ratio of Mg to Nd₂O₃ was used. Additionally, in the case where CaCl₂ was added as a flux, Nd₂O₃ and MgO will dissolve to a limited extent and form a slag. This partial dissolution of the oxides could result in their activity being less than unity. Examining the reaction quotient, it is apparent that the equilibrium concentration of Nd can be increased by decreasing the activity of MgO, or by increasing the activity of Nd₂O₃ and Mg. A decrease in the activity of the oxides caused by the formation of a liquid oxide-chloride slag phase could potentially push reduction further towards completion, because a decrease in the activity of MgO would have a greater effect in pushing the reduction towards Nd formation than the corresponding push in the other direction caused by a decrease in Nd₂O₃ activity, due to the difference in the exponents between the two terms in the reaction quotient.

These effects can be modeled by simulating reduction with HSC. By varying the molar ratio of Nd₂O₃ to Mg, the behavior of the reduction system is modeled in the low-Nd₂O₃ region, where high extent of reduction and very little residual Nd₂O₃ are possible, as is the case with the reduction experiments described above. The “Equilibrium Calculations” module in HSC 9 was used to simulate reduction, which takes initial reactant amounts and a description of the behavior of the reactant activities, and outputs the equilibrium composition of that system at various temperatures. The effect of varying the initial Nd₂O₃ amount was modeled by selecting a temperature (800° C.) and an initial arbitrary amount of Mg and an amount of CaCl₂ in the same CaCl₂/Mg ratio used in reduction experimentally, then performing the equilibrium composition calculation from an Nd₂O₃/Mg ratio of 0 to 0.5 (0.33 is the stoichiometric ratio). The extent of reduction as well as the equilibrium Nd concentration in the Mg—Nd alloy formed during reduction was plotted against the initial ratio of Nd₂O₃ to Mg (FIG. 20). The dashed line indicates the region corresponding to the reduction carried out experimentally, showing that the model predicts an extent of reduction of close to 100% and for the composition of the Mg—Nd alloy produced under these conditions to contain 4 at. % (20 wt. %) Nd, which corresponds well to experimental results.

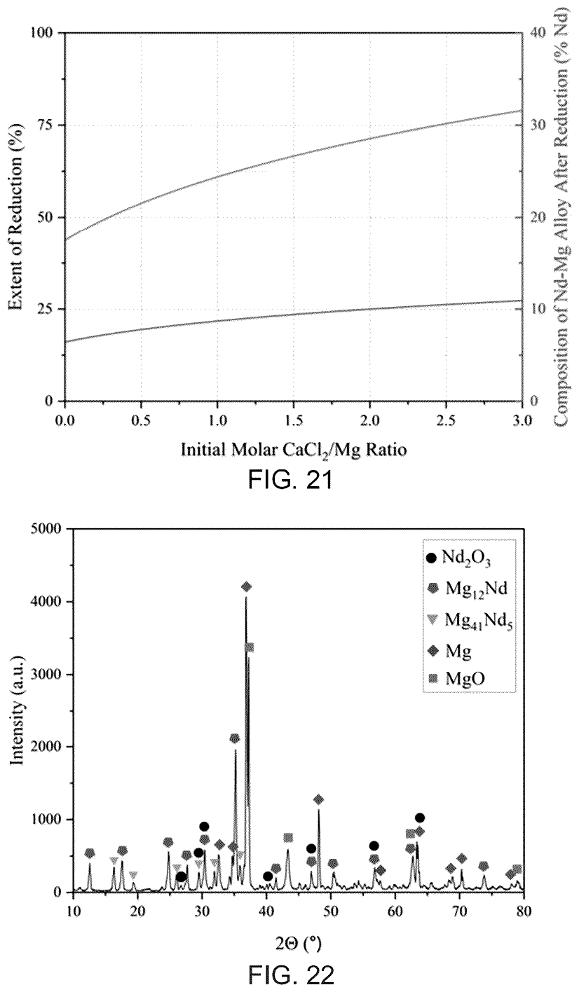

The model can also vary the molar ratio of CaCl₂ to Mg to examine the potential effects of the formation of a slag phase. The Mg and Nd were modeled as before, assuming that they form an ideal mixture with activity equal to mole fraction, and then for the oxides the model uses the extreme case where their activity is equal to their mole fraction in an ideally mixed slag phase containing both oxides as well as CaCl₂. As before, the equilibrium composition of the system was plotted vs. the CaCl₂/Mg ratio as well as extent of reduction and equilibrium Nd concentration (FIG. 21).

This shows that in addition to initial Nd₂O₃ mole fraction, reduction extent is likely also a function of the amount of flux used during reduction, however to a less extreme degree than the model predicts since it considers the slag to be an ideal mixture, which is likely not the case. Both the effect on reduction caused by initial Nd₂O₃ ratio and flux amount can be exploited in order to achieve complete reduction of Nd₂O₃ using Mg, despite the fact that the Ellingham diagram suggests that this pathway should not be feasible. In all cases, the modeled composition of the Mg—Nd alloy is in the 5-10 mole % Nd range, which matches well with the experimental results showing Nd and Mg forming an Mg—Mg₄₁Nd₅ two-phase microstructure, which is stable in that composition range according to the phase diagram. The models also suggest that if Mg—Nd alloy with greater fraction of Nd is desired, more Nd₂O₃ can be added at the cost of not achieving 100% reduction extent. However, these models demonstrate useful trends, specifically that full reduction is possible in the low-Nd₂O₃ region of the equilibrium composition versus initial Nd₂O₃ mole fraction diagram, and that this region can be expanded with the addition of a flux despite the fact that the flux can be “inert” with respect to Mg and Nd.

In the past, this use of a large excess of Mg to drive the reduction to completion would have made vacuum distillation to separate the reduced Nd prohibitively expensive. Unlike vacuum distillation, the use of H₂ to precipitate reduced Nd from the molten solution as NdHₓ and physically separating it would not scale in cost with the amount of excess Mg used. In the experiments described above, a hydrogen atmosphere was applied, which formed a thin layer of NdHₓ on the surface of the molten Mg—Nd solution. However, in an industrial process utilizing this technology, the surface area of the reaction between H₂ and Nd can be increased by blowing H₂ through the molten Mg—Nd and then exploiting the difference in density between the two (1.738 g/cm³ for Mg and 5.936 g/cm³ for NdH₂) to separate them, rather than merely forming a surface layer. This can have the effect of increasing the reaction rate and total amount of formed NdHₓ.

This process has the potential to compete with MSE in terms of low reagent cost, without the downsides of direct CO₂ and PFC emissions, making it an attractive alternative. The large excess of Mg used in this process could simply be reused after NdHₓ precipitation, theoretically meaning the only consumption is the Mg oxidized during reduction. Additionally, the selectivity of hydride precipitation means this method has the potential to be able to accept lower purity Nd₂O₃ than MSE (depending on the identity of the impurity species), reducing cost by eliminating additional purification steps in the beneficiation of Nd₂O₃ from ore.

In summary, the experimental results support the following conclusions: First, the ability of Mg to fully reduce Nd₂O₃ to Nd when the atom ratio of Nd₂O₃ to Mg is in the vicinity of 0.02, resulting in a roughly Mg—Nd alloy containing roughly 20 wt. % Nd. Next, the ability of Mg to fully reduce Nd₂O₃ is enabled by the formation of a liquid Mg—Nd solution at the reduction temperature, causing the two species to behave as a mixture thermodynamically. Further, the addition of H₂ can precipitate solid, pure NdHₓ from a melt of this Mg—Nd alloy. Finally, NdHₓ can be converted to Nd simply by heating above the decomposition temperature of around 760° C.

### Example 2

Another set of reduction, dissolution, and hydride precipitation experiments were carried using the same equipment as above. The heating rates in these experiments were all 5° C. per minute. The cooling rate and the end of the runs was not controlled. All initial reactant ratios were 2 g Nd₂O_{3/8} g Mg, and these reactants were mixed homogenously in a stainless-steel crucible. The Nd₂O₃ was calcined at 500° C. for one hour to convert any Nd(OH)₃ to oxide and stored under an inert atmosphere. Two comparative reduction experiments were performed. The first examined the effect of Ar vs. H₂ atmosphere on reduction. The samples were heated to 700° C. for 5 hours under 100% Ar or H₂ flowing at 1 L/min before characterization. The second experiment explored whether NdHₓ can be precipitated from molten Mg—Nd. Reduction was performed at 800° C. for 5 hours under 1 L/min Ar. In one case the sample was then allowed to cool. In the other case, the temperature was ramped to 675° C. over the course of 6 hours under 100% H₂ at 1 L/min before being allowed to cool.

For the experiment attempting to precipitate larger NdHₓ crystals for analysis, Mg—Nd alloy was produced using reduction and dissolution at 800° C. under Ar as described previously. 10 grams of this alloy was taken and mixed with 10 grams of anhydrous CaCl₂ and heated to 800° C. and held for 30 minutes under 100% Ar. The atmosphere was then switched to 100% H₂ and the temperature was ramped down to 650° C. over the course of 12 hours before the furnace was allowed to cool.

NdHₓ was separated and dehydrogenated to Nd metal by taking Mg—Nd alloy and heating it to 1100° C. and holding for 2 hours. The furnace was held under H₂ during the temperature ramp until 800° C., at which point the atmosphere was switched to Ar for the rest of the run.

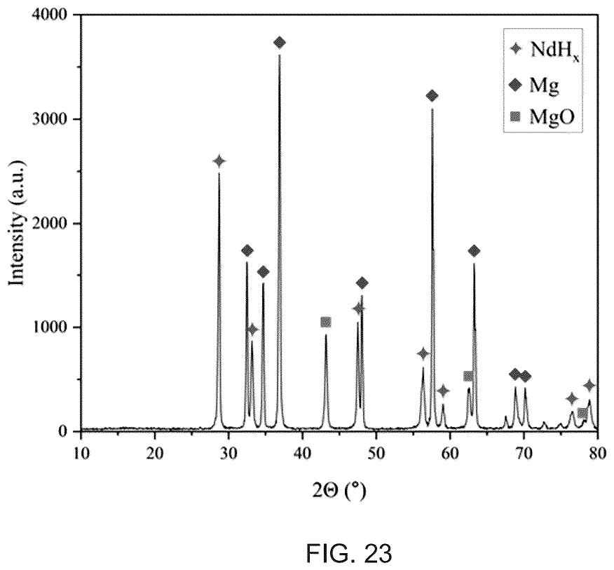

Reduction was first performed at 750° C. under Ar and H₂ to determine what products would form during reduction and to compare how complete reduction was between the two conditions. It was found that reduction at this temperature resulted in a friable powder with no melting or physical separation of reduction products being observed. However, the reduction product in this condition was suitable for analysis using XRD. These XRD spectra are displayed in FIG. 22 (XRD spectrum of material reduced in Ar) and FIG. 23 (XRD spectrum of material reduced in H₂). In the Ar case, reduction resulted in a mixture of Mg and the intermetallic compounds Mg₁₂Nd and Mg₄₁Nd₅, as well as both MgO and Nd₂O₃. The presence of Nd₂O₃ in the system after reduction suggests that reduction is incomplete. In the H₂ case, the only species present after reduction are Mg, MgO, and NdHₓ. The lack of Nd₂O₃ peaks in the sample reduced under H₂ suggests that reduction is complete in this condition, and confirms that the presence of H₂ is able to drive magnesium-based reduction to completion.

Reduction was then attempted at a higher temperature of 800° C. It was found that reduction at 800° C. created the desired phase separation, with the oxides sintering together and shrinking, leaving a void in the crucible that liquid Mg—Nd then filled. Reduction was repeated at this temperature under Ar using the same initial reactant ratio as the previous experiment. In one case the furnace was then allowed to cool, while in the other case the temperature decreased to 650° C. under H₂. In both cases a cross-section of the metal phase was cut and dry-polished for EDS analysis. It was found that in the Ar atmosphere case, the metal phase consisted of an Mg—Nd alloy containing roughly 3.5 at. % (17.7 wt. %) Nd. The Nd concentration in the Mg—Nd alloy can be used to determine the extent of reduction. For a given initial reactant ratio the theoretical amount of Nd in the Mg—Nd alloy can be calculated given 100% reduction based on the amount of Nd in the system and the amount of Mg that would be consumed to produce that Nd given the stoichiometry of the reaction. This gives a reduction extent of ˜95% assuming that conditions in the crucible are at equilibrium. The microstructure of the alloy consisted of darker primary α-Mg grains surrounded by a eutectic mixture of Mg and a lighter Nd-rich intermetallic compound. The eutectic nature of the Nd-rich grain boundary phases makes spot characterization via EDS unreliable, however the bulk Nd concentration of the Mg/Mg—Nd eutectic (which should underestimate the amount of Nd in the Mg—Nd intermetallic compound) was found to be 8.7 at. % (36.0 wt. %), suggesting that the Mg—Nd intermetallic forming during cooling is the equilibrium species Mg₄₁Nd₅ (theoretically 10.9 at. % Nd) rather than Mg₁₂Nd (7.9 at. % Nd). The primary α-Mg grains also contained intragranular Mg—Nd intermetallic compound Widmanstätten plates that were too small to characterize with EDS. XRD analysis of the oxide puck showed very similar results with reduction under Ar at 750° C., with the presence of Nd₂O₃ confirming that reduction was still incomplete.

In the case where the system was ramped down to 650° C. under H₂, a layer of NdHₓ˜300 μm thick precipitated at the liquid metal/gas interface. EDS of the precipitated hydride shows only Nd. It was found that the bulk Nd concentration in the Mg—Nd decreased from 3.5 at. % to 0.7 at. % (4.0 wt. %) after hydride precipitation. Significantly less Nd-rich intermetallic compound was seen at the boundaries between the primary Mg grains. It is currently unclear whether the value of 0.7 at. % is the thermodynamic minimum, which is dictated by the magnitude of the free energy of mixing between Nd and liquid Mg, or if this value is limited kinetically by Nd diffusion rate, H₂ access, etc. If this value is limited thermodynamically, higher H₂ pressure could potentially be used to achieve a lower bulk Nd concentration than was achieved under these conditions. XRD analysis of the oxide puck was once again very similar to reduction under H₂ at 750° C., with a lack of Nd₂O₃ suggesting complete reduction. Significant entrainment of Mg—Nd alloy was present in the oxide pucks of both reduction conditions, which is detrimental to the yield of this step.

Because NdHₓ precipitates as a pure solid at the liquid metal/gas interface, separation of NdHₓ from the Mg—Nd becomes possible, negating the issue of having to use vacuum distillation to remove the large excess of Mg used during reduction. If this separation is performed during the reduction step, the depletion of Nd from the liquid Mg—Nd phase caused by NdHₓ precipitation can be leveraged to create a semi-continuous process for Nd production. For example, a reactor can include two chambers connected with a pipe allowing for mass flow between them: a reduction chamber where Nd₂O₃ reacts with Mg, forming MgO and Mg—Nd solution at a concentration of 3.5 at. %, and a precipitation chamber, where liquid Mg—Nd is exposed to H₂, forming NdHₓ that is then removed. As Nd concentration in the precipitation chamber is depleted to the equilibrium value of 0.7 at. %, the reduction chamber is continually pushed away from equilibrium, driving more Nd reduction and net flux of Nd towards the precipitation chamber. The MgO byproduct can be managed and removed, and Nd₂O₃ can be added to the reduction chamber to create a steady-state continuous process.

### Example 3

Magnets were sourced from computer hard drives. These magnets were oxidized and contaminated to varying degrees. About 1 kg of hard drives magnets (still attached to their brackets) were obtained. Hydrogen decrepitation was used to pulverize and de-magnetize the magnets, and separate them from the brackets. This was done by heating to 300° C. under 100% H₂ for 1 hour in a retort furnace. This material was then crushed with a mortar and pestle and sieved to −40 mesh to recover the magnet powder (FIGS. 1 and 2).

This decrepitated magnet powder was then mixed with Mg in a 1 g magnet powder: 1.6 g Mg ratio and heated to 800° C. for 5 hours for dissolution and alloying. This ratio was used to produce Mg—Nd/RE alloy with similar concentration to the Mg—Nd alloy produced from oxide. At this condition, Nd will preferentially dissolve into Mg, depleting the NdFeB to ˜1.0 at. % Nd from a theoretical starting point of 11 at. %, resulting in a Fe/FeB waste. This waste settled to the bottom of the crucible while Mg—Nd remained on top. The other rare earths in the starting magnet material dissolve similarly to Nd.

In the same step, hydride precipitation was performed to separate the rare earths from the molten Mg—Nd alloy. In this example, the temperature was decreased to 675° C. and a molybdenum paddle was inserted at the molten metal/gas interface. The atmosphere was switched from Ar to 100% H₂ and the paddle was rotated every 30 minutes to collect precipitating rare earth-hydride (e.g. predominantly Nd hydride). This was carried out for 12 hours. The paddle was then removed and the furnace was allowed to cool. This procedure was repeated three more times to collect additional rare earth-hydride.

The collected hydride was removed from the paddle and dehydrogenated in a molybdenum crucible at 1100° C. for 2 hours under Ar. This step converted the rare earth-hydride to rare earth-metal. The composition of this metal was analyzed and shown in Table 1 in comparison to the starting composition of the magnet feedstock.

TABLE 1
Composition of feed material versus the final recovered rare earth alloy. Cells
include semi-quantitative analysis via EDS, quantitative analysis via ICP
from Luvak Inc., quantitative analysis via LECO, and estimated values.

| | Element (wt. %) | | | | | | | | | | |
|---|---|---|---|---|---|---|---|---|---|---|---|
| | Total | | | | | | | | | | Other |
| | RE | Nd | Pr | Dy | Fe | B | Ni | Mg | O | C | Metal |
| Feed | 36.5 | 30.41 | 6.09 | <1 | 60.09 | 0.009 | 2.72 | — | 0.61 | 0.07 | <1 |
| Material | | | | | | | | | | | |
| Final Re | 96.25 | 85.45 | 8.23 | 2.57 | 2.78 | 0.003 | 0.23 | 0.14 | 0.52 | 0.03 | 0.05 |
| Alloy | | | | | | | | | | | |

What is claimed is:

1. A method of producing a neodymium metal, comprising:
mixing a dissolution agent with a neodymium-containing feedstock, wherein the dissolution agent comprises magnesium;
heating the mixed dissolution agent and feedstock to an elevated temperature above a melting temperature of the dissolution agent to form a neodymium-magnesium alloy;
exposing the neodymium-magnesium alloy to hydrogen gas to convert neodymium in the alloy to a neodymium hydride;
separating the neodymium hydride from the magnesium in the alloy; and
optionally dehydrogenating the neodymium hydride to form a neodymium metal.

2. The method of claim 1, further comprising separating a waste material from the neodymium-magnesium alloy.

3. The method of claim 1, wherein the heating step and the exposing the alloy to hydrogen gas step are performed at least partially simultaneously.

4. The method of claim 1, wherein the neodymium-magnesium alloy is exposed to hydrogen gas after the heating, wherein the mixed dissolution agent and feedstock are heated under an argon atmosphere followed by the hydrogenating under a hydrogen atmosphere.

5. The method of claim 1, wherein the neodymium-magnesium alloy is exposed to hydrogen under a hydrogen atmosphere, or by bubbling hydrogen gas through the alloy in a molten state, or a combination thereof.

6. The method of claim 1, wherein a fluxing agent is mixed with the dissolution agent and the feedstock.

7. The method of claim 6, wherein the fluxing agent is selected from the group consisting of a halide salt, a borate-based flux, or a combination thereof.

8. The method of claim 6, wherein the fluxing agent comprises CaCl₂.

9. The method of claim 6, wherein a weight ratio of neodymium to the fluxing agent during the heating is from about 1:5 to about 1:3.

10. The method of claim 1, wherein the dissolution agent is Mg metal, MgH₂, or a combination thereof.

11. The method of claim 1, wherein the feedstock is a neodymium oxide-containing material and wherein the heating step further comprises a portion of the magnesium dissolution agent acting as a reducing agent to reduce the neodymium oxide.

12. The method of claim 11, wherein MgO is a byproduct of reducing neodymium oxide.

13. The method of claim 11, wherein the weight ratio of neodymium oxide in the feedstock to the dissolution agent when the feedstock is mixed with the dissolution agent is from about 1:5 to about 1:3.

14. The method of claim 1, wherein the feedstock comprises a neodymium-containing waste, a recycled neodymium-containing material, a neodymium-containing scrap material, or a combination thereof.

15. The method of claim 14, wherein the feedstock comprises a recycled neodymium magnet material.

16. The method of claim 14, further comprising hydrogenating the feedstock before mixing the feedstock with the dissolution agent.

17. The method of claim 16, further comprising comminuting the feedstock before mixing the feedstock with the dissolution agent.

18. The method of claim 1, wherein the mixed dissolution agent and feedstock are heated at a temperature from about 560° C. to about 850° C.

19. The method of claim 1, wherein the neodymium-magnesium alloy is exposed to hydrogen at a hydrogenation temperature from about 560° C. to about 850° C.

20. The method of claim 1, wherein the separation temperature from about 560° C. to about 850° C.

21. The method of claim 1, wherein the dehydrogenation is performed at a dehydrogenation temperature from about 760° C. to about 1100° C.

22. The method of claim 1, wherein separating the neodymium hydride from the magnesium comprises separating the neodymium hydride from the alloy by precipitating the neodymium hydride as a solid from the alloy in a molten state.
